(19) United States
(12) Patent Application Publication
(10) Pub. No.: US 2026/0289129 A1
(43) Pub. Date: Sep. 24, 2026

(54) SYSTEM

(71) Applicant: SoftBank Group Corp., Tokyo (JP)

(72) Inventor: Hiroyuki MIZUNO, Tokyo (JP)

(73) Assignee: SoftBank Group Corp., Tokyo (JP)

(21) Appl. No.: 19/567,381

(22) Filed: Mar. 16, 2026

(30) Foreign Application Priority Data
Mar. 19, 2025 (JP) 2025-045078

(51) Int. Cl. G06F 40/289; G06F 40/284; G06F 40/35; G06N 3/0475; G10L 25/63

(52) U.S. Cl. CPC G06F 40/289; G06F 40/35; G06N 3/0475; G06F 40/284; G10L 25/63

(57) ABSTRACT

A system includes a processor that is configured to receive an input from a user, generate a first prompt that instructs a generative AI model to perform analysis of the received input, refer to past sales histories and evaluations, automatically collect and analyze evaluation comments, extract a need of the user by using a natural language processing technique, recognize an emotion of the user and apply an emotion analysis algorithm to adjust a proposal based on the recognized emotion, and generate a second prompt that instructs the generative AI model to generate proposal content for proposing an optimal gift based on an analysis result and emotion information.

### CROSS-REFERENCE TO RELATED APPLICATION

This application is based on and claims priority under 35 USC 119 from Japanese Patent Application No. 2025-045078 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional gift recommendation systems generally rely on fixed rules, simple keyword matching, or statistical correlation between user attributes and product purchase histories. Such systems often fail to accurately understand a user's true needs expressed in natural language, and they do not adequately consider contextual factors, such as nuanced preferences or the emotional state of the user at the time of inquiry. As a result, conventional systems tend to propose gifts that are generic, poorly personalized, or not aligned with the user's current intent and feelings.

Moreover, while user reviews and evaluation comments contain rich information regarding product characteristics and user satisfaction, conventional systems typically make only limited use of such text data, for example by utilizing numerical ratings or basic keyword counts. Conventional systems do not sufficiently analyze evaluation comments using advanced natural language processing to derive user tendencies or to deeply characterize products in a way that meaningfully supports personalized proposals.
In addition, existing recommendation techniques generally do not employ generative AI models in a structured manner to both interpret user input and compose optimized proposal content. Even when generative AI is used, prompts tend to be handcrafted and static, and the systems are not designed to dynamically generate prompts based on past sales histories, review analyses, extracted user needs, and recognized emotional states. Consequently, current approaches lack robustness and adaptability when confronted with diverse natural language inputs and complex user contexts.
Furthermore, many existing systems do not recognize or effectively utilize the emotional state of the user, such as excitement, anxiety, gratitude, or hesitation, in the recommendation process. Ignoring user emotion may lead to recommendations that are logically relevant but emotionally inappropriate or insufficiently persuasive from the user's perspective.
Accordingly, there is a need for a system that can: (i) accurately analyze user input using a generative AI model and natural language processing, (ii) comprehensively leverage past sales histories and evaluation comments, (iii) recognize the user's emotion and adjust proposals based on the recognized emotion, and (iv) generate prompts for a generative AI model so as to create proposal content that optimally matches both the user's needs and emotional state.

### SUMMARY

To solve the above problems, according to one aspect of the present invention, there is provided a system comprising a processor, wherein the processor is configured to receive an input from a user; generate a first prompt that instructs a generative AI model to perform analysis of the received input; refer to past sales histories and evaluations; automatically collect and analyze evaluation comments; extract a need of the user by using a natural language processing technique; recognize an emotion of the user and apply an emotion analysis algorithm to adjust a proposal based on the recognized emotion; and generate a second prompt that instructs the generative AI model to generate proposal content for proposing an optimal gift based on an analysis result and emotion information.

In particular, the processor is configured to cause the generative AI model, via the first prompt, to interpret the semantic content of the user input, including implicit intentions and constraints expressed in natural language. The processor acquires past sales histories and evaluation data corresponding to candidate gift items, and automatically gathers associated evaluation comments as text data. The processor then applies natural language processing techniques to the evaluation comments to extract product-level features and tendencies that are relevant for recommendation, such as perceived quality, design, suitability as a gift, and specific use cases.
In one embodiment, the processor is configured to analyze the evaluation comments by using a natural language processing technique, and to extract keywords from the evaluation comments to identify a preference or a tendency of the user. For example, by extracting and aggregating keywords frequently associated with positive evaluations for items that are similar to those of interest to the user, the processor can infer the user's likely preferences with respect to design, functionality, brand, or price range. These inferred tendencies are then used as parameters for selecting and ranking candidate gifts.
Further, the processor is configured to recognize an emotion of the user from the input using an emotion analysis algorithm. The emotion analysis algorithm may determine, for example, whether the user expresses joy, anxiety, gratitude, or uncertainty. The processor adjusts the proposal strategy and the tone or emphasis of the generated proposal content based on the recognized emotion, such that the final gift recommendation is both contextually and emotionally appropriate.
Moreover, the processor is configured to generate the second prompt, which encodes the analysis result of the user input, the extracted needs, the identified preferences and tendencies, the summarized review information derived from evaluation comments, and the recognized emotional state. By supplying this second prompt to the generative AI model, the processor causes the generative AI model to generate detailed proposal content that describes one or more optimal gifts, together with reasoning or explanation tailored to the user's needs and emotions.
In another embodiment, the processor is configured to generate a prompt for the generative AI model through a dialogue with the user to grasp the need and the emotion of the user, and to adjust the proposal content so as to propose a gift appropriate for the need and the emotion of the user. Specifically, the processor can conduct multi-turn interaction, asking clarification questions or follow-up questions as necessary, and incrementally updating the prompts supplied to the generative AI model as more information about the user's needs and emotional state becomes available. In this way, the system dynamically refines both the analysis of user requirements and the resulting gift proposals.
By employing the above configuration, the system according to the present invention is capable of: (i) deeply understanding user input using a generative AI model; (ii) effectively leveraging past sales histories and evaluation comments through natural language processing; (iii) recognizing the user's emotional state and reflecting such state in the recommendation; and (iv) automatically constructing prompts that enable the generative AI model to generate proposal content for optimal gifts, thereby providing highly personalized and contextually suitable gift recommendations.

The term “processor” refers to one or more hardware computing units, such as a central processing unit (CPU), graphics processing unit (GPU), application-specific integrated circuit (ASIC), or system-on-chip (SoC), and may further include associated control logic capable of executing instructions to perform the functions described in the claims.

The term “user” refers to a human operator who interacts with the system, for example by providing natural language inputs, reviewing proposed gifts, and optionally supplying additional information or feedback through a terminal.
The term “terminal” refers to an electronic device operated by the user, such as a personal computer, smartphone, tablet, or dedicated kiosk, which is configured to transmit user inputs to the system and to display proposal content received from the system.
The term “generative AI model” refers to a machine learning model, such as a large language model or other generative neural network, that is configured to generate text or other content in response to an input prompt.
The term “prompt” refers to information supplied to the generative AI model, including text, parameters, or structured data, that instructs the generative AI model regarding a task to perform, such as analyzing user input or generating proposal content.
The term “first prompt” refers to a prompt generated by the processor that instructs the generative AI model to perform analysis of the received user input, including interpretation of semantics, intent, and context expressed in natural language.
The term “second prompt” refers to a prompt generated by the processor that incorporates analysis results and emotion information and that instructs the generative AI model to generate proposal content for proposing an optimal gift.
The term “past sales histories” refers to data representing previous transactions of products, including quantities sold, time periods of sales, and optionally customer attributes or contexts associated with those transactions.
The term “evaluations” refers to data representing user assessments of products, including numerical ratings, review comments, feedback scores, or other evaluation indicators.
The term “evaluation comments” refers to textual content written by users or customers to describe their opinions, experiences, and impressions about purchased products or gifts.
The term “natural language processing technique” refers to a computational method or algorithm for processing and analyzing natural language text, including but not limited to tokenization, part-of-speech tagging, syntactic parsing, semantic analysis, keyword extraction, and sentiment analysis.
The term “extract a need of the user” refers to identifying, from the user's natural language input, one or more requirements, intentions, constraints, or purposes related to a desired gift, such as target recipient, occasion, budget, or preferred product characteristics.
The term “emotion analysis algorithm” refers to a computational method for detecting or estimating an emotional state of the user from natural language input or related data, such as determining whether the user is happy, anxious, confused, grateful, or hesitant.
The term “recognize an emotion of the user” refers to determining, using the emotion analysis algorithm, one or more emotional states or tendencies expressed by the user in the provided input or during a dialogue.
The term “proposal” refers to a recommendation or suggestion for one or more gifts, including explanatory text or reasoning, that is presented to the user as a result of processing performed by the system.
The term “adjust a proposal” refers to modifying the content, tone, prioritization, or selection of recommended gifts based on analysis results, extracted needs, preferences, tendencies, or recognized emotional states of the user.
The term “optimal gift” refers to at least one gift item selected by the system as being most suitable for the user's extracted needs, preferences, and recognized emotional state, taking into account past sales histories, evaluations, and analysis results.
The term “preference or a tendency of the user” refers to one or more inferred likes, dislikes, habitual choices, or behavioral patterns of the user, such as favored styles, brands, price ranges, or product categories, derived from analysis of evaluation comments or other data.
The term “dialogue with the user” refers to an interactive exchange of messages between the user and the system, conducted through the terminal, in which the user provides information or answers and the system outputs questions, clarifications, or proposals in multiple conversational turns.
The term “proposal content” refers to textual or structured information generated by the generative AI model in response to a prompt, including descriptions of recommended gifts, reasons for selection, comparisons, and other explanatory elements provided to the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

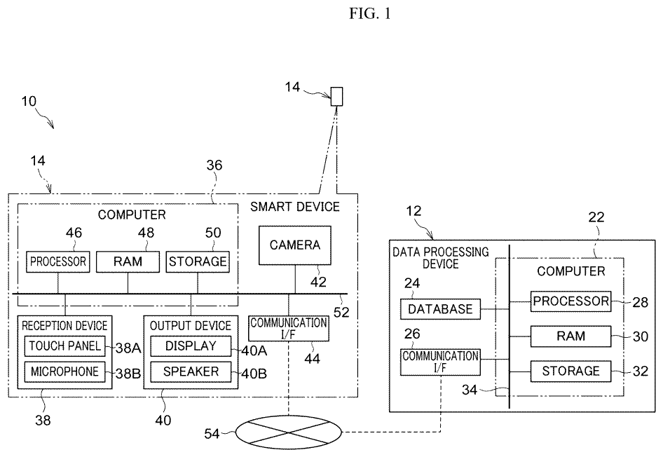

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

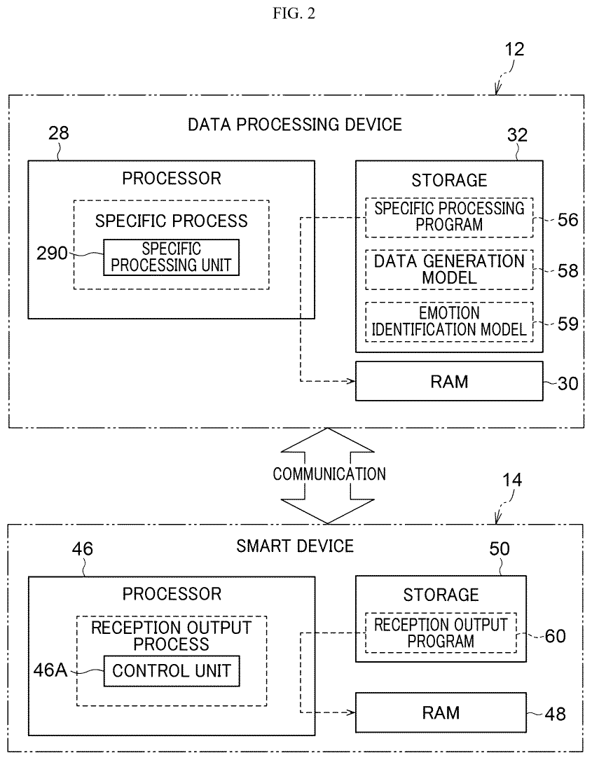

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional gift recommendation systems that process natural language input typically treat user queries, transaction history, and evaluation comments as separate data sources and apply fixed heuristic rules or simple statistical filtering. Such systems often rely on manually defined keyword lists, static scoring formulas, or general-purpose recommendation engines that are not optimized for understanding nuanced user needs and contextual factors such as specific events, recipients, and implicit constraints. As a result, these systems may generate recommendations that are only loosely related to the user's actual intent, lack explainability, and fail to leverage the full richness of available evaluation comments.

In addition, existing systems frequently apply natural language processing to user queries in an isolated manner, without tightly integrating the outputs of advanced generative models with downstream data retrieval, evaluation comment analysis, and ranking processes. This can lead to inefficient processing pipelines in which the system repeatedly reinterprets user input or transfers unstructured text between components, consuming computing resources and introducing latency. Furthermore, evaluation comments stored in large-scale databases are often underutilized, being reduced to simple average ratings or coarse sentiment labels, which does not adequately exploit the detailed feature-level feedback expressed by users. From a computer technology standpoint, there is a need for a system architecture and processing method that: (i) uses a generative artificial intelligence model in a structured manner through explicitly formed prompt sentences; (ii) converts user natural language input into structured user need information suitable for efficient database querying; (iii) applies natural language processing to evaluation comments to automatically derive feature-level sentiment and evaluation trend information; and (iv) integrates these analyses into a unified ranking mechanism that computes composite evaluation values for items. Without such an integrated approach, the computational resources used for recommendation processing are not efficiently directed toward items that best match the user's context, and the system cannot effectively balance transaction history, evaluation trends, and nuanced user constraints. Accordingly, there is a technical problem in the field of computer-based information processing to provide an improved server-side processing architecture that systematically orchestrates prompt-based interaction with a generative artificial intelligence model, structured retrieval from storage devices, automatic feature and sentiment extraction from evaluation comments using natural language processing, and ranking computation. The challenge is to design processing steps and data flows that reduce redundant text processing, improve the quality and relevance of suggested items, and enable the generation of coherent natural language recommendation sentences, while maintaining scalability and response speed as the volume of transaction and evaluation data increases.

The specific processing by the specific processing unit 290 of the data processing device 12 in Example 1 is realized by the following means.

The present invention provides a server comprising a processor configured to receive, via a terminal, user requests expressed in natural language and convert the requests into text information; to generate structured prompt sentences for a generative artificial intelligence model, the structured prompt sentences including the text information, and to input the structured prompt sentences to the generative artificial intelligence model so as to obtain structured user need information including at least event information, recipient information, and constraint information; to execute query processing on a storage device storing transaction history information and evaluation information based on the structured user need information in order to retrieve multiple item records including sales performance information and evaluation comments; to apply natural language processing to the evaluation comments so as to perform segmentation and linguistic classification, calculate feature terms and sentiment polarity, and generate, for each item record, feature information and evaluation trend information; to compute, for each item record, a composite evaluation value based on at least the feature information, the evaluation trend information, and the sales performance information, and to select candidate item records suitable for the structured user need information by ranking the item records based on the composite evaluation value; to generate recommendation prompt sentences including information on the selected candidate item records and the structured user need information, and to input the recommendation prompt sentences to the generative artificial intelligence model so as to obtain natural-language recommendation sentences describing the candidate item records; and to transmit response information including the recommendation sentences and corresponding candidate item information to the terminal for presentation to the user. This enables an integrated, computer-implemented recommendation pipeline in which the generative artificial intelligence model is systematically driven by explicit prompt sentences to produce structured user need information and recommendation sentences, the storage device is accessed through intent-aware queries, and evaluation comments are automatically transformed into feature-level sentiment and trend data, thereby improving the technical efficiency and relevance of recommendation processing and enhancing the quality of output recommendations in large-scale transaction and evaluation environments.

The term “processor” refers to a hardware-implemented computation unit, such as a central processing unit or a processing circuit, configured to execute instructions that implement the functions described in the system.
The term “terminal” refers to an information processing apparatus operated by a user, such as a client device or user interface device, that transmits user input to the server and presents response information received from the server.
The term “user request” refers to information expressing a user's intention or need, provided in natural language via the terminal, and processed by the server as text information.
The term “text information” refers to data representing characters or strings obtained from the user request, which can be processed by natural language processing components and a generative artificial intelligence model.
The term “prompt sentence” refers to a structured textual input, including at least part of the user request or item information, provided to a generative artificial intelligence model to instruct the model to perform a specific analysis or generation task.
The term “analysis prompt sentence” refers to a prompt sentence constructed to cause the generative artificial intelligence model to analyze the user request and output structured user need information.
The term “recommendation prompt sentence” refers to a prompt sentence constructed to cause the generative artificial intelligence model to generate a natural-language recommendation sentence based on selected candidate item information and user need information.
The term “generative AI model” refers to a trained machine learning model, such as a neural network-based language model, configured to generate or transform text in response to a provided prompt sentence.
The term “structured user need information” refers to data representing the user's intent in a machine-readable, organized form, including fields such as event information, recipient information, and constraint information.
The term “event information” refers to data indicating a context or occasion associated with the user's request, such as a type of event, celebration, or scenario for which an item is to be recommended.
The term “recipient information” refers to data indicating an intended receiver or target of an item associated with the user's request, such as a relationship type or demographic attributes.
The term “constraint information” refers to data indicating conditions or requirements specified by the user, such as the use of past sales data, use of evaluation information, price range, or other limitations to be considered in recommendation processing.
The term “information storage device” refers to a memory or storage subsystem, such as a database or storage medium, configured to store transaction history information, evaluation information, and item data.
The term “transaction history information” refers to data representing past transactions, including at least purchased items, dates, quantities, and associated events or contexts.
The term “evaluation information” refers to data representing users'assessments of items, including at least evaluation comments, ratings, or other feedback data.
The term “target item pieces of information” refers to item-related records retrieved from the information storage device, each record including at least identification of an item and associated sales performance information and evaluation information.
The term “sales performance information” refers to data indicating quantitative performance of items, such as sales volume, frequency, or aggregated statistics for a predetermined period.
The term “evaluation comment” refers to a textual feedback entry associated with an item, provided by a user or evaluator, and stored as part of the evaluation information.
The term “natural language processing” refers to a set of computational techniques and algorithms applied to text information, including at least segmentation, linguistic classification, tokenization, part-of-speech tagging, parsing, feature extraction, and sentiment analysis.
The term “segmentation” refers to a natural language processing operation that divides text into smaller units, such as sentences, phrases, or tokens, to facilitate further linguistic analysis.
The term “linguistic classification” refers to natural language processing operations including, for example, assigning part-of-speech tags, syntactic roles, or other linguistic categories to tokens in text.
The term “feature term” refers to a word or phrase identified from evaluation comments that corresponds to an attribute, characteristic, or aspect of an item.
The term “sentiment polarity” refers to a quantitative or qualitative indication of the positive, negative, or neutral sentiment associated with text, such as evaluation comments or feature terms.
The term “feature information” refers to data describing features or attributes of an item, derived from at least feature terms and associated sentiment polarity values extracted from evaluation comments.
The term “evaluation trend information” refers to data indicating temporal or aggregated patterns of evaluations for an item, including trends in sentiment polarity or rating distribution over a period.
The term “composite evaluation value” refers to a computed score for an item obtained by combining multiple factors, including at least feature information, evaluation trend information, and sales performance information.
The term “candidate item” refers to an item selected from among multiple target items based on ranking using the composite evaluation value as being suitable for the structured user need information.
The term “response information” refers to data transmitted from the server to the terminal, including at least a recommendation sentence and corresponding candidate item information, for presentation to the user.
The term “recommendation sentence” refers to natural-language text generated by the generative artificial intelligence model, describing one or more candidate items in a manner suitable for presentation to the user.

In one embodiment, a server operates as an information processing apparatus configured to generate gift recommendations based on natural language input, transaction history, and evaluation comments. The server cooperates with one or more terminals operated by users. The server includes at least one processor, a main memory, a non-volatile storage device, and a communication interface. The server executes software modules that implement prompt generation, generative AI model interfacing, database querying, natural language processing, feature and sentiment extraction, composite scoring, and response formatting. The server uses computing hardware such as a multi-core central processing unit and, in some embodiments, one or more graphics processing units optimized for matrix computation. For example, the server can employ a general-purpose server platform running an operating system such as a UNIX-like server operating system, and use a database management system such as a relational database engine to store transaction history and evaluation information. The server can execute application logic using a high-level programming language runtime, and can execute machine learning models on a neural network inference framework such as a tensor-based computation framework. The terminal uses a user interface environment, such as a web browser or native application framework, to capture user input and render recommendation results.

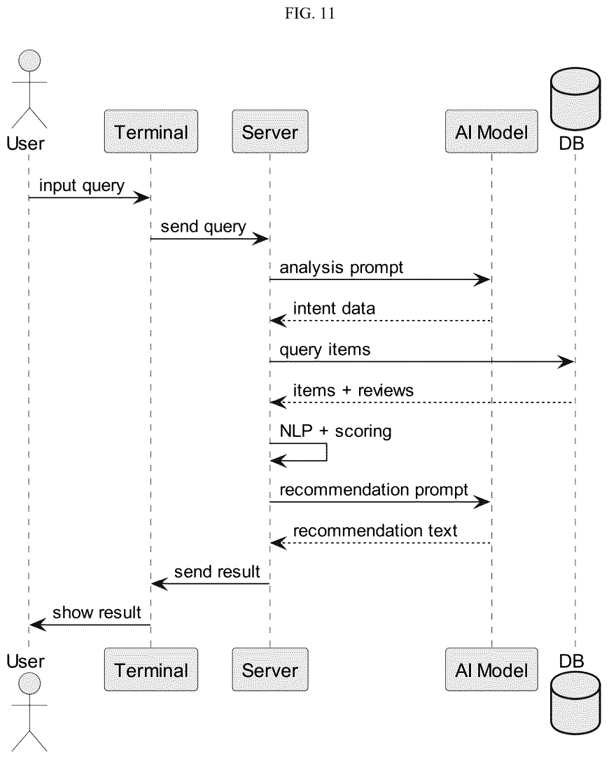

In an exemplary configuration, the server stores transaction history information and evaluation information in a relational database. The server maintains a transaction table including, for each transaction, an item identifier, a timestamp, an event label, a quantity, and optional attributes such as price or category identifiers. The server maintains an evaluation table including, for each evaluation, an item identifier, a rating value, and an evaluation comment in natural language. The server further maintains an item table including, for each item, an item identifier, a title, a category label, a price, and metadata such as tags or attributes.
The server uses the generative AI model as a neural network-based language model. In one embodiment, the generative AI model is implemented as a transformer-based architecture having multiple attention layers, feed-forward layers, and layer normalization components. The server stores model parameters as multi-dimensional arrays representing weights and biases in the attention heads and feed-forward layers. The server configures the model with a vocabulary embedding layer that maps tokens to dense feature vectors, one or more self-attention blocks that compute attention scores using scaled dot products, and an output projection layer that converts hidden states to token probability distributions.
The server trains or fine-tunes the generative AI model using a corpus that includes task-specific examples such as user queries paired with structured intent representations and examples of recommendation sentences conditioned on item features. The server applies supervised learning with an objective such as cross-entropy loss between predicted token sequences and reference sequences. The server performs backpropagation through the transformer architecture to compute gradients of the loss with respect to model weights, and updates the weights using an optimization algorithm such as a variant of stochastic gradient descent. The server can also perform data augmentation by paraphrasing training prompts or sampling alternative phrasings, which causes the model to generalize better to varied user inputs.
The server uses two conceptual modes of the generative AI model: an analysis mode driven by an analysis prompt sentence, and a recommendation mode driven by a recommendation prompt sentence. In the analysis mode, the server constructs a prompt sentence that instructs the generative AI model to convert a free-form natural language query into structured user need information. For example, the server can generate the following analysis prompt sentence:
“You are an intent extraction engine for a gift recommendation system.
Input: ‘Please recommend a gift for Mother's Day based on past sales and reviews.’
Task: Extract the event, recipient, and any constraints.
Output JSON with fields: event, recipient, constraints.”
   Although this prompt references a JSON-like output format, the server treats the entire response as text and parses the response into structured data by applying deterministic pattern matching or parsing logic, such as searching for key labels “event”, “recipient”, and “constraints” and extracting the associated values.
   In the recommendation mode, the server generates a prompt sentence that contains structured item information and user need information, and instructs the generative AI model to produce a fluent natural language recommendation. For example, the server can generate the following recommendation prompt sentence:
“You are an assistant that writes gift recommendations based on product data.
User intent: Mother's Day gift for mother.
   Candidate products (with features and trends):
1. Floral Aroma Candle Set: price=30.00, total_sales=5420, average rating=4.7, features=[‘gentle floral fragrance’, ‘relaxing effect’, ‘elegant design’], trend=‘mostly very positive reviews over the past 3 years’.
2. Premium Flower Bouquet: price=40.00, total_sales=4850, average rating=4.6, features=[‘fresh flowers’, ‘colorful arrangement’, ‘gift-ready packaging’], trend=‘consistently high satisfaction’.
Task: Based on the above, write a friendly recommendation in English for the user, explaining why these products are suitable as Mother's Day gifts.”
   The server sends the prompt sentence to the generative AI model, receives the generated character sequence, and treats this sequence as the recommendation sentence. The server stores the recommendation sentence together with the associated item identifiers, and transmits them to the terminal in a response format suitable for rendering.
   The server applies natural language processing outside the generative AI model to evaluation comments in order to generate feature information and evaluation trend information. The server uses a pipeline that includes tokenization, part-of-speech tagging, dependency parsing, and sentiment analysis. The server may employ a separate neural network, such as a bidirectional encoder model, trained on a sentiment classification task. The server feeds tokenized evaluation comments into this encoder model, obtains contextual embeddings per token, and applies a classification layer to predict sentiment polarity values. The server aggregates sentiment polarity per feature term by counting occurrences and averaging sentiment scores. The server stores, in a structured data format, for each item, a list of feature terms (for example, “scent”, “design”, “packaging”) and an associated sentiment score and summary phrase.
   The server computes a composite evaluation value for each item by combining multiple factors. The server normalizes sales performance information, such as total sales within a specified period, to a scaled range. The server normalizes average rating values and aggregated sentiment polarity scores. The server then computes a weighted sum according to a predefined or adjustable weighting scheme, for example assigning a first weight to sales performance, a second weight to rating values, and a third weight to feature-level sentiment. The server stores the composite evaluation value as a numeric field associated with each item record.
   The server selects candidate items by sorting the item records according to the composite evaluation value and optionally applying additional filters based on event information, recipient information, or constraint information. The server then extracts a subset of items having the highest composite evaluation values. This ranking algorithm differs from manual or rule-based ranking because it integrates neural-network-derived feature sentiment with transactional statistics in a single score optimized for machine computation. The server thus reduces the need for multiple passes of human-defined rule evaluation, which results in improved computational efficiency.
   The server thereby improves computer technology by optimizing the internal data flow and computation order. By converting user queries into structured user need information using the analysis prompt sentence, the server performs database queries using indexable fields, such as event labels and item identifiers, rather than performing full-text searches on unstructured user queries. This reduces the load on the database engine and decreases latency. By precomputing or incrementally updating feature-level sentiment and evaluation trend information, the server avoids repeatedly re-analyzing the entire corpus of evaluation comments for each query. Instead, the server can update sentiment aggregates in a batch process or in response to new evaluations, and the recommendation process accesses these aggregated features directly, improving response time.
   The server uses distinct prompt sentences and an explicit structuring of data exchanged with the generative AI model. This non-conventional prompt orchestration causes the generative AI model to produce machine-readable intent representations and human-readable recommendation sentences in a predictable format, thereby allowing the server to reduce post-processing overhead and parsing ambiguity. In contrast to systems that merely forward user queries to a language model and display the output, the server enforces structured interaction patterns that are specifically designed to enhance database query efficiency and recommendation precision.
   The server thereby achieves technical advantages including improved computation efficiency, improved recommendation accuracy, and reduced network traffic. The server reduces network traffic by transferring compact structured data (such as intent fields and ranked item identifiers) between internal modules instead of large unstructured text blocks. The server also reduces the number of calls to the generative AI model by using the model primarily for two well-defined tasks—intent extraction and recommendation sentence generation—rather than repeatedly invoking the model at multiple intermediate stages.
   The terminal operates as a client that interacts with the server. The terminal presents an input interface that accepts natural language queries from the user, transmits them as structured messages to the server, and receives response information including recommendation sentences and candidate item information. The terminal displays, for example, the recommendation sentence as a text block and the candidate items as a list with names, prices, ratings, and selectable controls. The user can review the recommended items and perform further actions such as navigating to a purchase interface.
   The user provides natural language queries tailored to various contexts. For instance, the user can enter: “Please recommend gifts for Mother's Day. Consider past sales performance and customer reviews when making suggestions.” In another example, the user can enter: “Please suggest a birthday gift for a male colleague in his 30s, using items that have high ratings and many positive comments.” The server applies the same internal mechanism to both queries, but the structured user need information differs in event type, recipient type, and constraints, causing the ranking and item selection to adapt accordingly.
   In some embodiments, the server supports interactive refinement of recommendations. The server receives additional inputs from the user such as follow-up questions, for example: “She likes relaxing items more than flowers. Can you recommend something related to aroma or wellness?” The server generates an updated analysis prompt sentence incorporating the initial query and the follow-up text, and re-invokes the generative AI model in analysis mode. The server obtains updated structured user need information that reflects the new constraints or preferences, such as inclusion of feature terms “relaxing” or “aroma”. The server adjusts the ranking of candidate items by increasing the weights assigned to items with positive sentiment on relevant features. This dynamic refinement based on internal feature representations is different from simple filtering and allows more precise adaptation with minimal additional computational cost.
   The server can employ alternative implementations for the generative AI model interface. In one variation, the server hosts the generative AI model locally and invokes it through a local inference library. In another variation, the server communicates with a remote model service over a network using an application programming interface. In either case, the server composes textual prompt sentences and interprets textual responses using the same processing pipeline, making the architecture portable across different model deployments.
   The server can vary the neural network architecture used for natural language processing of evaluation comments. In some embodiments, the server uses a recurrent neural network-based model or a convolutional neural network-based model for sentiment classification. The server can alter the number of layers, hidden units, and activation functions to balance accuracy and computational cost. The server can also employ different loss functions depending on task requirements, such as categorical cross-entropy for discrete sentiment labels or mean squared error for continuous sentiment scores.
   The server is thus configured to perform more than a simple automation of human judgment. Human operators conventionally inspect evaluation comments manually and use subjective impressions to assess items. In contrast, the server decomposes the evaluation comments into consistent feature terms, quantifies sentiment polarity numerically, and aggregates these values across large datasets. This consistent quantitative representation enables the server to simultaneously process thousands or millions of evaluations and to update composite evaluation values in a manner that leverages computational parallelism and vectorized operations on modern processors.
   The server provides improvements in technical fields such as database management, text processing, and neural network inference by integrating these components in a non-standard way. The use of structured user need information derived from prompt-driven generative analysis allows the server to select query predicates that align with indexing strategies of the underlying storage engine, reducing query execution time. The pre-aggregation of feature-level sentiment and evaluation trends reduces the size and complexity of in-memory data structures processed during ranking, thereby reducing memory footprint and improving cache efficiency. The prompt design that separates analysis and recommendation functions minimizes the length and complexity of each model invocation, reducing inference latency and resource usage on the neural network accelerator.
   In summary, the server, the terminal, and the user cooperate in an architecture where the server uses prompt sentences to control a generative AI model, applies detailed natural language processing to evaluation comments, and computes composite evaluation values for items based on structured signals. This integrated design yields technical improvements in processing speed, recommendation precision, and resource utilization compared with conventional systems that treat natural language and evaluation data in a less structured manner.
   The following describes the processing flow using FIG. 11.

### Step 1:

The user operates the terminal to input a request in natural language, such as “Please recommend a gift for Mother's Day based on past sales and reviews.”
The terminal receives the character sequence as input, converts it into an internal text string, and encapsulates the text string and metadata (for example, user ID and timestamp) into a request message.
The terminal outputs the request message by transmitting it to the server over a communication network using a communication protocol.

### Step 2:

The server receives the request message from the terminal as input through a communication interface.
The server parses the message, extracts the natural language text string and metadata, and stores the raw text and metadata in a log storage for traceability.
The server outputs the extracted text string and associated context data as internal variables for subsequent processing.

### Step 3:

The server uses the extracted text string as input to construct an analysis prompt sentence.
The server embeds the user's text into a predefined template, for example:
“You are an intent extraction engine for a gift recommendation system.
Input: ‘Please recommend a gift for Mother's Day based on past sales and reviews.’
Task: Extract the event, recipient, and any constraints.
Output JSON with fields: event, recipient, constraints.”
   The server concatenates fixed instruction segments and the variable user text, performing string operations such as insertion and escaping of special characters.
   The server outputs the completed analysis prompt sentence as a single text block ready to be sent to the generative AI model.

### Step 4:

The server provides the analysis prompt sentence as input to the generative AI model.
The server encodes the prompt sentence into token IDs using a tokenizer, maps the token IDs to embedding vectors, and forwards the embeddings through multiple transformer layers comprising attention and feed-forward units.
The generative AI model performs vectorized matrix multiplications and non-linear activations to compute probability distributions over output tokens and generates a response sequence that represents structured user need information, such as:
“{‘event’: ‘Mother's Day’, ‘recipient’: ‘mother’, ‘constraints’: [‘use past sales data’, ‘use review data’]}”
   The server decodes the generated token sequence back into text, then applies pattern matching or parsing (for example, locating the substrings after “event”: and “recipient”: delimiters) to extract event, recipient, and constraint values.
   The server outputs structured user need information as a data structure including at least event information, recipient information, and constraint information.

### Step 5:

The server uses the structured user need information as input to construct one or more database queries.
The server maps the event information (for example, “Mother's Day”) to an event field in a transaction table, and selects a time window (for example, the last three years) based on configuration.
The server generates a query such that items purchased for the specified event within the time window are selected, and aggregate functions such as SUM on quantity and AVG on rating are applied.
The server sends the query to the storage engine, which executes index lookups and aggregation operations.
The server receives a result set as output, including item identifiers, aggregated sales performance information, rating values, and references to evaluation comments.

### Step 6:

The server uses the result set from the storage engine as input and retrieves detailed evaluation comments for the listed items.
The server constructs a second query or a join condition to obtain all comments from an evaluation table where the item identifier matches any of the selected items.
The server collects the evaluation comments and associates them with the corresponding item identifiers, forming, for each item, a list of comment strings and rating values.
The server outputs a structured collection where each item entry contains basic item attributes, aggregated sales performance, average rating, and a list of raw evaluation comments.

### Step 7:

The server uses each item's list of evaluation comments as input to a natural language processing pipeline.
The server tokenizes each comment into words or subword units, tags each token with part-of-speech categories, and applies dependency parsing to identify relationships between tokens.
The server applies a sentiment analysis model (for example, a neural network-based classifier) that receives token embeddings and outputs a sentiment polarity score for the comment, and optionally for specific segments associated with feature terms.
The server identifies feature terms such as “scent”, “design”, or “packaging” by scanning for noun phrases and predefined attribute patterns and then aggregates sentiment scores by feature term (for example, computing mean polarity and frequency of mentions).
The server outputs, for each item, feature information (a list of feature terms with associated aggregated sentiment scores and occurrence counts) and evaluation trend information (for example, an overall sentiment score and time-based trend metrics).

### Step 8:

The server uses, as input, the feature information, evaluation trend information, and sales performance information for each item.
The server normalizes numeric values (for example, scaling total sales, average ratings, and sentiment scores to a common range using min-max normalization or z-score normalization).
The server computes a composite evaluation value for each item by applying a weighted combination, such as:

composite_value=w1*normalized_sales+w2*normalized_rating+w3* normalized_sentiment,

where w1, w2, and w3 are coefficient parameters stored in configuration.
The server then sorts the items in descending order of the composite evaluation value and selects the top-ranked items as candidate items that best match the structured user need information.
The server outputs a ranked list of candidate item records including item identifiers, attributes, composite evaluation values, and summarized feature information.

### Step 9:

The server uses the ranked candidate items and structured user need information as input to construct a recommendation prompt sentence.
The server formats the top N items as textual descriptions, including names, prices, key features, and trends, and inserts them into a prompt template, for example:
“You are an assistant that writes gift recommendations based on product data.
User intent: Mother's Day gift for mother.
Candidate products (with features and trends):
1. Floral Aroma Candle Set: price=30.00, total_sales=5420, average rating=4.7, features=[‘gentle floral fragrance’, ‘relaxing effect’, ‘elegant design’], trend=‘mostly very positive reviews over the past 3 years’.
2. Premium Flower Bouquet: price=40.00, total_sales=4850, average rating=4.6, features=[‘fresh flowers’, ‘colorful arrangement’, ‘gift-ready packaging’], trend=‘consistently high satisfaction’.
Task: Based on the above, write a friendly recommendation in English for the user, explaining why these products are suitable as Mother's Day gifts.”
   The server concatenates the fixed instructions and dynamically generated product summaries, ensuring proper line breaks and separators.
   The server outputs the completed recommendation prompt sentence as text ready to be processed by the generative AI model.

### Step 10:

The server provides the recommendation prompt sentence as input to the generative AI model.
The server encodes the prompt text into tokens, passes them through the neural network layers, and obtains output token probabilities at each time step to generate a response sequence corresponding to a recommendation sentence.
The generative AI model generates coherent natural language text, for example:
“For Mother's Day, a floral aroma candle set is an excellent choice. It has a gentle, relaxing fragrance and an elegant design that many customers praise, and it has received very high ratings over the past three years. If your mother enjoys flowers, a premium flower bouquet with fresh, colorful blooms and gift-ready packaging is also highly recommended.”
   The server decodes the token sequence into a string, optionally trims or post-processes the text (for example, removing extraneous control tokens), and links the generated text to the identifiers of the items referenced in the prompt.
   The server outputs the final recommendation sentence together with structured candidate item information.

### Step 11:

The server uses the recommendation sentence and candidate item information as input to generate a response message for the terminal.
The server constructs a data structure containing the recommendation sentence, item identifiers, names, prices, and any additional fields needed by the terminal UI.
The server serializes the data structure into a transmission format and sends the response through the communication interface to the terminal.
The server outputs the response message onto the network as a completed unit of response data.

### Step 12:

The terminal receives the response message from the server as input through its communication module.
The terminal parses the message, extracts the recommendation sentence and candidate item fields, and updates the user interface by rendering the text and listing the candidate items with selectable controls.
The terminal may perform local formatting, such as wrapping text, arranging items in a list or grid, and displaying buttons for “View details” or “Add to cart.”
The terminal outputs the formatted recommendation view to the display, enabling the user to visually perceive the recommendation and interact with the suggested items.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation systems for gift selection typically rely on simple rule-based filters, static keyword matching, or basic statistical ranking based on aggregate ratings and sales counts. Such systems suffer from several technical limitations when operating on large-scale, heterogeneous data generated by many users and many events. First, these systems are not configured to efficiently integrate unstructured evaluation comments, structured sales history, and contextual user input (such as event type, budget, and recipient attributes) into a unified representation that can be processed in real time. As a result, the underlying information processing pipeline often becomes a bottleneck, leading to increased computational load, suboptimal memory usage, and latency that is unsuitable for interactive user interfaces on resource-constrained client devices.

Second, existing systems generally process user-generated text and evaluation comments using isolated components that are loosely coupled, such as separate sentiment analysis modules and independent ranking modules. This fragmented architecture makes it difficult for the computer to maintain consistent intermediate representations across components, thereby limiting the quality and stability of the ranking results. In particular, conventional systems do not systematically generate and reuse structured evaluation features (for example, event suitability indices, temporal variation of sentiment, and topic distributions) as first-class inputs to downstream ranking and generative models. This leads to repetitive computations, inconsistent scoring, and inefficient utilization of machine learning accelerators such as graphics processing units.
Third, many systems that use generative models treat such models as stand-alone text generators, without tightly integrating them with the computer's ranking computations and data structures. In such systems, prompts to generative models are often ad hoc, lacking explicit inclusion of machine-readable features derived from evaluation comments and sales history. Consequently, the generative models have limited access to the internal state of the recommendation engine, resulting in outputs that are not aligned with the system's computed ranking or that require additional post-processing. This disconnect increases processing overhead and complicates the software architecture, thereby reducing the overall efficiency and reliability of the information processing system.
Fourth, conventional architectures do not provide a unified prompt generation mechanism that systematically converts multi-modal internal data (including user input, evaluation features, composite scores, and sales history) into structured prompt sentences optimized for generative models. Without such a mechanism, the computer cannot fully exploit the capabilities of generative models for producing coherent, context-aware explanations and recommendations. This not only degrades user experience but also prevents the system from leveraging generative models to offload certain natural language processing tasks from traditional, hand-crafted logic, which could otherwise reduce complexity and improve maintainability.
Therefore, there is a need for an improved computer-implemented system and method that (i) unifies the processing of user input, structured transaction data, and unstructured evaluation comments, (ii) generates stable and reusable evaluation features via machine learning models, (iii) integrates these features into a composite ranking computation, and (iv) programmatically constructs structured prompt sentences for generative models. Such a system should enhance computational efficiency, reduce latency, and improve the quality and consistency of recommendation outputs and explanatory texts, thereby representing a concrete improvement to computer technology used for interactive recommendation services.

The specific processing by the specific processing unit 290 of the data processing device 12 in Application Example 1 is realized by the following means.

The present invention provides a server comprising a processor configured to receive user input expressed in natural language via a communication interface, convert the user input into structured information including at least an event type, budget information, and recipient attributes, retrieve, based on the structured information, product information and past sales history information for candidate gift items from a relational data storage device, acquire evaluation comments associated with the candidate gift items from the relational data storage device, preprocess the evaluation comments as text data to generate numerical data including distributional representation conversion, tokenization, and length normalization, input the numerical data into a machine learning model including a natural language processing model to generate analysis results including an emotion index, an event suitability index, and a topic classification index for the evaluation comments, integrate the analysis results with the past sales history information and the product information to calculate, for each candidate gift item, a composite evaluation value indicating a recommendation degree, rank the candidate gift items based on the composite evaluation value, generate a prompt sentence including structured information summarizing the user input, the analysis results, the past sales history information, and the composite evaluation value so as to cause a generative information processing model to execute input analysis or proposal generation, input the prompt sentence into the generative information processing model to obtain natural language output including gift recommendation content and explanatory text, and generate, based on the natural language output and the ranked candidate gift items, a list of candidate gift items and explanatory information to be presented to a client device. This enables the server to improve the technical operation of the recommendation pipeline by unifying structured and unstructured data processing, reducing redundant computations across analysis and ranking stages, efficiently utilizing machine learning resources for feature extraction, and tightly integrating generative models through structured prompt sentences, thereby reducing processing latency, improving resource utilization, and producing more accurate and consistent recommendation results and explanations.

The term “system” refers to an information processing arrangement including at least one hardware device and at least one software component configured to execute the claimed functions.

The term “processor” refers to one or more hardware processing units, such as a central processing unit, a graphics processing unit, or a specialized accelerator, configured to execute instructions and perform arithmetic and logical operations.
The term “user input” refers to information provided by a human operator to the system, expressed in natural language or via a user interface, and including at least information about a desired gift or event.
The term “natural language” refers to a human language, such as English or Japanese, that is not constrained to a formal programming or query language syntax.
The term “structured information” refers to data represented in a predefined format, such as key-value pairs, records, or tables, including at least an event type, budget information, and recipient attributes.
The term “event type” refers to a classification of an occasion or context, such as a holiday, celebration, or life event, for which a gift item is to be selected.
The term “budget information” refers to data indicating a monetary range or constraint associated with the purchase of a gift item.
The term “recipient attributes” refers to information describing a person or entity intended to receive a gift, including at least demographic, preference, or relationship characteristics.
The term “candidate gift item” refers to a product or service that is considered by the system as a possible recommendation for a gift.
The term “relational data storage device” refers to a storage system managed by a relational data management program that organizes data in tables with rows and columns and supports structured query operations.
The term “product information” refers to data describing characteristics of items, including at least identifiers, names, categories, pricing, and rating information.
The term “past sales history information” refers to transaction-related data indicating previous sales events, including at least quantities sold, time of sale, and aggregate performance indicators.
The term “evaluation comment” refers to text data created by users or customers expressing opinions, feedback, or assessments regarding an item or service.
The term “preprocessing” refers to a series of operations applied to raw data to convert the data into a format suitable for machine learning, including at least normalization, tokenization, and representation conversion.
The term “numerical data” refers to data represented as numeric values, such as vectors, matrices, or tensors, that are suitable for input into a machine learning model.
The term “distributional representation conversion” refers to a transformation that maps textual elements such as words or tokens into numerical vectors based on their usage patterns in a corpus.
The term “tokenization” refers to a process that segments a text string into smaller units, such as words, subwords, or symbols, to be used as input elements for further processing.
The term “length normalization” refers to an operation that adjusts token sequences to a uniform length, including at least truncation or padding, for compatibility with fixed-size model inputs.
The term “machine learning model” refers to a computational model that has been trained using data to perform a task such as classification, regression, ranking, or generation, and that adjusts internal parameters during training to improve performance.
The term “natural language processing model” refers to a machine learning model specialized for processing, analyzing, or generating human language text.
The term “analysis results” refers to output values produced by the machine learning model based on input data, including at least indices and scores used for subsequent calculations.
The term “emotion index” refers to a numerical indicator representing an estimated emotional polarity or intensity expressed in evaluation comments.
The term “event suitability index” refers to a numerical indicator representing a degree to which an item is estimated to be appropriate for a particular event type.
The term “topic classification index” refers to a numerical indicator or label representing one or more topics or aspects identified in evaluation comments.
The term “composite evaluation value” refers to an aggregated numerical score for a candidate gift item, computed from multiple features including analysis results, sales history information, and product information, and indicating a recommendation degree.
The term “ranking” refers to an operation that orders candidate gift items according to a criterion, such as the composite evaluation value, from highest to lowest or vice versa.
The term “generative information processing model” refers to a machine learning model configured to generate new data, such as natural language text, in response to input data, including large language models and other generative architectures.
The term “prompt sentence” refers to a text or structured textual input provided to a generative information processing model to specify a task, context, or constraints for generating output.
The term “natural language output” refers to text generated by a generative information processing model, expressed in a human language and including recommendation content or explanatory content.
The term “gift recommendation content” refers to natural language output that proposes one or more candidate gift items to a user based on analysis performed by the system.
The term “explanatory text” refers to natural language output that indicates reasons, criteria, or background information for recommending particular candidate gift items.
The term “evaluation features” refers to derived data values, including aggregated scores and statistical measures, computed from evaluation comments and other inputs and used in ranking or further processing.
The term “event-related score” refers to a numerical value indicating how strongly an evaluation comment is related to a specific event type according to the machine learning model.
The term “distribution information” refers to statistical information describing the spread or variability of a set of values, such as variance, quantiles, or histograms.
The term “temporal variation” refers to a change in values or scores over time, represented as a time-dependent pattern or trend.
The term “client device” refers to a computing device operated by a user, such as a mobile terminal, tablet, or personal computer, configured to send requests to and receive responses from the server.
The term “output device” refers to a hardware component, such as a display, speaker, or printer, that presents information from the system to a user.

The server executes a recommendation program on a hardware platform that includes at least one central processing unit, a main memory, a non-volatile storage device, a network interface, and optionally a graphics processing unit configured for numerical computation. The server runs an operating system such as a general-purpose server operating system and an application stack including a web application framework and a relational data management program. The server stores program instructions and machine learning model parameters in the non-volatile storage device, loads them into the main memory, and executes them on the processor to implement the functions described below.

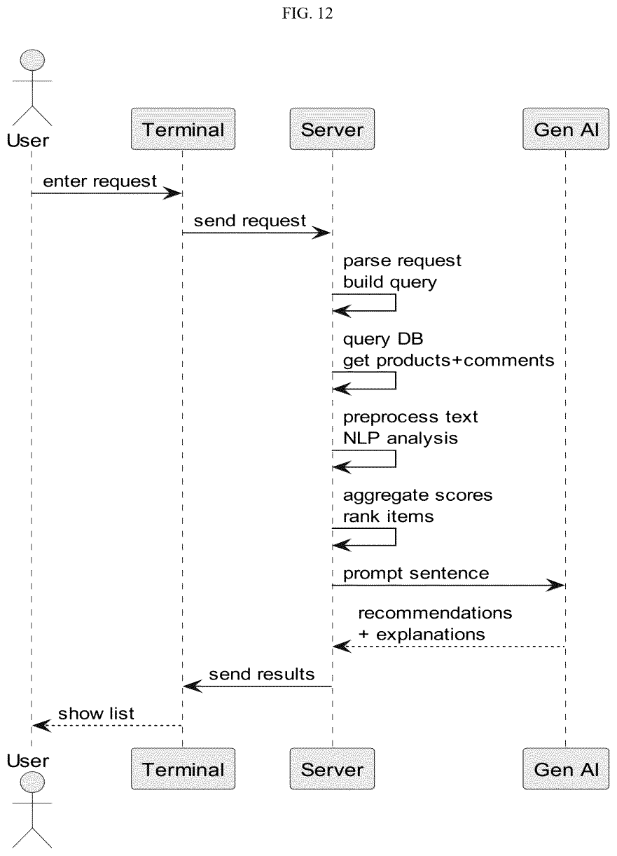

The server maintains a relational data schema including at least a product table, a product-event association table, a product comment table, and a product statistics table. The product table stores records with fields such as product identifier, product category, price, average rating, and media resource identifiers. The product-event association table stores fields such as product identifier and event tag, where the event tag indicates an event type (for example, “Mother's Day,” “birthday,” or “wedding”). The product comment table stores fields such as comment identifier, product identifier, user identifier, timestamp, and comment text. The product statistics table stores aggregated fields such as total sales count, return rate, and time-series sales data. The relational data management program maintains indexes on fields such as product identifier, event tag, and timestamp to allow efficient query processing. The server stores, in addition to these relational tables, one or more machine learning models implemented as trained neural networks. The server stores a natural language processing model for comment analysis as a sequence model or a transformer-based model. In one embodiment, the server stores a transformer-type neural network including multiple attention layers, feed-forward layers, and layer normalization components. The server represents the model parameters (for example, weight matrices and bias vectors) as floating-point tensors in the non-volatile storage device. The server loads the parameters into the main memory and uses a numerical computation framework such as a tensor computation library to perform matrix multiplications, non-linear activation functions, and normalization operations.
The server also stores a generative AI model, for example a large language model, that is trained to accept a prompt sentence and structured context information and to output natural language text. The server represents the generative AI model as a multi-layer neural network, such as a decoder-only transformer, configured with self-attention layers, positional encodings, and token embedding matrices. The server stores a tokenizer that maps character sequences to token identifiers and an embedding matrix that maps those token identifiers to numerical vectors. The server uses these components when encoding prompt sentences and decoding output tokens.
The terminal operates as a client device, such as a smartphone, tablet, or personal computer, equipped with a display, input interface, local processor, memory, and a communication module. The terminal executes a client application that presents a graphical user interface to the user. The client application stores temporary data, such as user session information and cached product images, in local memory or local storage. The terminal uses a secure network protocol to send and receive messages to and from the server.
The user interacts with the system by operating the terminal. The user enters natural language text into an input field, for example “I am looking for a Mother's Day present for my mother, budget around 50 dollars,” or selects options from predefined UI elements describing event type, budget, and recipient attributes. The terminal converts the user input into a structured request message including at least a user identifier, an event type code, a budget range, recipient attributes, and optionally raw text. The terminal transmits the structured request message to the server via the communication module using a standardized communication protocol.
The server receives the structured request message and stores request metadata in a log storage structure, including timestamp, anonymized user identifier, event type, and other parameters. The server parses the structured request and maps the event type and budget constraints to query parameters for the relational data management program. The server executes queries that join the product table with the product-event association table and filter by event tag, price range, and availability. The server obtains a set of candidate product identifiers, along with base attributes such as product name, category, price, and aggregate rating.
The server acquires evaluation comments for the candidate product identifiers by executing queries on the product comment table. The server retrieves comment text and associated metadata, such as timestamps. The server stores the retrieved comments temporarily in the main memory in data structures grouped by product identifier. The server performs text normalization operations, such as converting to lower case, removing certain punctuation, normalizing whitespace, and optionally applying language-specific normalization rules. The server uses a tokenizer associated with the natural language processing model to divide each comment into tokens, and the server maps each token to a token identifier using a vocabulary mapping table.
The server forms fixed-length sequences of token identifiers by applying length normalization. When a comment contains more tokens than a predefined maximum length, the server truncates the sequence; when a comment contains fewer tokens, the server pads the sequence with a special padding identifier. The server then maps token identifiers to continuous-valued vectors using an embedding matrix associated with the natural language processing model, generating a matrix representation for each comment. The server inputs these matrices into the neural network model and performs numerical operations layer by layer. For attention layers, the server computes query, key, and value matrices, computes attention weights using scaled dot-products, and applies these weights to aggregate contextual embeddings. For feed-forward layers, the server applies linear transformations and non-linear activation functions such as rectified linear units or other suitable activation functions.
The server outputs, for each comment, numerical vectors that represent contextualized encodings. The server computes, from these encodings, an emotion index, an event suitability index, and a topic classification index. In one embodiment, the server passes the encodings through classification heads: for emotion index, a linear layer followed by a softmax function that outputs probabilities over emotion classes (for example, positive, neutral, negative) or a scalar sentiment score; for event suitability index, a linear layer that outputs a scalar indicating the degree of relevance to the specified event type; for topic classification index, a linear layer that outputs probabilities over predefined topics such as “quality,” “appearance,” “delivery,” and “suitability as a gift.” The server stores these indices as numeric values associated with each comment and each product identifier.
The server aggregates these per-comment indices across comments associated with the same product identifier. The server computes, for each product, evaluation features such as mean emotion score, variance of emotion score, proportion of strongly positive comments, mean event suitability index, and topic distribution statistics. The server optionally computes temporal variation features by weighting recent comments more heavily and measuring changes in sentiment or suitability over time. The server also retrieves sales history features for each product from the product statistics table, such as total sales count, recent sales count, and return rate, and combines them with the evaluation features to form a feature vector for each candidate product.
The server computes a composite evaluation value for each product by applying a ranking algorithm. In one embodiment, the server applies a learned ranking model, implemented as a feed-forward neural network, that accepts the feature vector as input and outputs a scalar score. The server configures this ranking model with parameters trained offline using historical data, a loss function such as a pairwise ranking loss or a mean squared error loss, and an optimization algorithm such as stochastic gradient descent or an adaptive gradient method. During training, the server or an associated training system adjusts the weights of the ranking network to minimize the loss between predicted scores and target labels derived from historical user interactions. During inference, the server uses the trained weights and does not perform further weight updates. In another embodiment, the server computes a weighted sum of normalized feature values with predetermined coefficients, where the coefficients are selected to emphasize sentiment, event suitability, and sales performance.
The server sorts the candidate products by the composite evaluation value to generate an ordered list. The server constrains the number of products to a predetermined maximum to limit the size of the response payload and to reduce rendering complexity on the terminal.
The server constructs summary information for each product, including its rank position, product attributes, key evaluation features (for example, average sentiment, share of event-related comments), and sales indicators.
The server constructs a prompt sentence for the generative AI model. The server concatenates natural language text describing the user's intent, a summarized list of candidate products and their key evaluation features, and instructions for the output format. The server may include explicit markers or delimiters to distinguish different segments of the context, such as “[USER_INPUT]” or “[PRODUCT_LIST].” For example, the server may generate a prompt sentence such as:
“User input: I am looking for a Mother's Day present for my mother, budget around 50 dollars.
Context: You are an assistant that recommends gift items based on user reviews and sales data.
Products and analysis (summarized):
Product A: high positive sentiment, frequently mentioned as ideal for Mother's Day, strong recent sales.
Product B: moderate sentiment, some mentions of suitability as a gift, stable sales.
Task: Please recommend the top 3 products for this user, and for each product, provide a concise explanation that references sentiment trends, mentions of ‘Mother's Day,’ and sales performance.”
   The server encodes this prompt sentence by applying the tokenizer and embedding matrix associated with the generative AI model. The server executes the generative AI model on the processor or on an attached accelerator. The server generates output tokens sequentially or in blocks according to the architecture of the generative AI model, using mechanisms such as autoregressive decoding with sampling or deterministic decoding with beam search. The server decodes the tokens into a natural language output string that includes recommendation content and explanatory text for each recommended product.
   The server parses the generated text and maps references to products (for example, “Product A,” “the first product,” or specific attributes) back to internal product identifiers. The server merges the generated explanations with the ranked product list and constructs a response message including the recommended products, their attributes, and the generated explanations. The server may also include additional fields indicating confidence scores or explanation categories. The server transmits the response to the terminal.
   The terminal receives the response, parses the structured data, and renders the recommended products on the display. The terminal presents the generated explanations to the user alongside thumbnails, prices, and ratings. The terminal allows the user to scroll, filter, and select specific items for further details. When the user selects an item, the terminal sends a detail request to the server, and the server responds with extended product information and further evaluation comment summaries.
   The server improves computer technology in several ways. By representing evaluation comments as numerical embeddings and precomputing attention-based indices, the server reduces the need for repetitive text scanning and string-based matching at query time, thereby lowering latency and computational load. By aggregating evaluation indices into reusable evaluation features and combining them with sales data in a unified ranking model, the server reduces redundancy between different modules and improves cache locality and data access patterns. This results in more efficient use of memory and processing resources. Furthermore, by generating structured prompt sentences that explicitly encode ranking features and internal context, the server enables the generative AI model to produce outputs that are already aligned with the calculated ranking, reducing the need for post-processing and additional passes over the data.
   The server uses a training pipeline for the neural networks that includes data selection, data augmentation, loss function definition, and weight update procedures. For the comment analysis model, the server or an associated training component selects historical comments with labels for sentiment, event suitability, and topic, applies tokenization and embedding, and computes a loss such as cross-entropy for classification tasks and mean squared error for regression tasks. The server updates the weight matrices using gradient-based optimization, computing gradients via backpropagation through attention layers and feed-forward layers. For the ranking model, the server uses feature vectors derived from historical user behavior (for example, clicks, dwell time, and purchases) and computes loss functions that penalize incorrect ranking orders. By training these models jointly or in a coordinated fashion, the server ensures that the intermediate evaluation features are informative for downstream ranking.
   The server employs non-conventional techniques that differ from simple automation of human judgment. For instance, the server assigns dynamic weights to evaluation features based on temporal patterns and event-specific behavior, such as increasing the weight of “Mother's Day” mentions near the event date. The server uses specific rules to select which comment-derived features to include in prompt sentences and how to compress them, ensuring that the prompt length remains within model constraints while preserving critical information. These rules are not merely an automation of manual curation but are derived from the structure of the neural networks and memory constraints of the computational platform, resulting in improved throughput and reduced communication overhead between modules.
   In alternative embodiments, the server may use different neural network architectures, such as recurrent neural networks, convolutional neural networks for text, or hybrid architectures that combine convolutional and attention mechanisms. The server may also adapt the tokenizer (for example, word-level, subword-level, or character-level) depending on the language and domain. The server may replace the relational data management program with a distributed data store that still supports structured queries over tables or equivalent structures.
   The server may run the generative AI model on a separate inference service that communicates over a high-speed network connection; in such configurations, the server still constructs prompt sentences as described and parses the responses.
   The terminal may operate as an embedded device in a kiosk, a voice-enabled device, or a vehicle-mounted device, where the generated recommendations are used to drive other equipment, such as activating audio announcements or controlling display layouts. The client application may cache partial model outputs or feature summaries locally to reduce repeated requests and thereby reduce network traffic and server load. In such embodiments, the server still performs core analysis and ranking, while the terminal focuses on user interaction and local rendering.
   The user may initiate different types of interaction, such as asking clarifying questions or providing feedback about recommendations. In some embodiments, the server constructs prompt sentences for the generative AI model to formulate follow-up questions to the user. For example, the server may generate a prompt such as:
“User input: I am looking for a present.
Task: Ask up to three concise follow-up questions to clarify the event type, budget, and recipient preferences.”
   The generative AI model outputs follow-up questions, which the server sends to the terminal. The user responds, and the server updates the structured information, repeating the analysis and ranking using the refined parameters. This loop improves the precision of the recommendations, while the underlying data structures and neural models remain consistent and efficient.
   By integrating structured relational data, neural network-based feature extraction, and generative AI output under a unified server-controlled framework, the system realizes technical effects such as reduced response time, improved accuracy of recommendations, better utilization of hardware accelerators, and reduced communication overhead. The server achieves these effects not simply by automating manual selection but by employing specific model architectures, training methods, data structures, and prompt construction rules that exploit the capabilities of modern computer hardware and software in a non-conventional manner.
   The following describes the processing flow using FIG. 12.

### Step 1:

The user operates the terminal to enter a natural-language request for a gift recommendation.
The user provides input such as “I am looking for a Mother's Day present for my mother, budget around 50 dollars.”
The terminal receives this text as input and converts it into a structured request that includes at least a user identifier, an event type, a budget range, and recipient attributes.
The terminal performs data processing by parsing the text, mapping phrases like “Mother's Day” to an internal event type code, mapping “around 50 dollars” to a numeric budget range, and packaging these values into a structured message.
The terminal outputs a request payload containing the structured fields and the original text, and transmits this payload to the server over a network connection.

### Step 2:

The server receives the request payload from the terminal as input through a communication interface.
The server parses the payload to extract the event type code, budget range, recipient attributes, and the raw natural-language text.
The server performs data processing by validating the extracted fields, normalizing the budget range, and mapping the event type code to one or more event tags used in the relational data storage.
The server outputs internal query parameters, including event tags, numeric price boundaries, and a user context descriptor, which are stored in working memory for subsequent database access.

### Step 3:

The server uses the internal query parameters as input to the relational data management program.
The server issues structured queries that join a product table with a product-event association table, filtering by event tags, price range, and availability.
The server performs data processing by executing index-based lookups and join operations within the relational engine, which scans relevant rows and applies filter conditions.
The server outputs a set of candidate product records, each including at least a product identifier, category, price, and aggregate rating, and stores these records in main memory as a candidate list.

### Step 4:

The server takes the candidate product identifiers as input and queries a product comment table to retrieve evaluation comments.
The server executes queries that filter comments by product identifier and, optionally, by language or recency.
The server performs data processing by grouping retrieved comment rows by product identifier and constructing for each product a list of associated comment texts and timestamps.
The server outputs a data structure that maps each product identifier to its corresponding collection of evaluation comments and associated metadata.

### Step 5:

The server uses the comment texts as input to a text preprocessing pipeline.
The server performs operations such as lowercasing, punctuation removal, whitespace normalization, and language-specific normalization, followed by tokenization using a predefined tokenizer.
The server then converts tokens to token identifiers using a vocabulary mapping and applies length normalization by truncating or padding sequences to a fixed length.
The server performs data processing by mapping each comment to a fixed-length sequence of token identifiers and then to a matrix of embedding vectors using an embedding matrix associated with the natural language processing model.
The server outputs numerical tensors representing each comment, which are suitable for input to the neural network-based analysis model.

### Step 6:

The server inputs the numerical tensors for the comments into a machine learning model configured as a natural language processing model.
The server performs data processing by propagating the tensors through multiple layers of the neural network, including attention layers and feed-forward layers, and computing contextualized encodings for each token sequence.
The server then applies classification or regression heads to these encodings to compute an emotion index, an event suitability index, and a topic classification index for each comment.
The server outputs, for each comment, a set of numeric scores representing emotional polarity, relevance to the event, and topic probabilities, and stores these scores in association with the corresponding product identifiers.

### Step 7:

The server uses the per-comment indices as input to an aggregation module.
The server performs data processing by grouping indices by product identifier and computing aggregate statistics such as mean emotion score, variance of emotion scores, proportion of highly positive comments, and mean event suitability index.
The server may also compute temporal features by weighting scores from recent comments more heavily than older comments, using timestamp metadata.
The server outputs, for each product, an evaluation feature vector that summarizes the sentiment, event relevance, and topic distribution derived from its associated comments.

### Step 8:

The server takes the evaluation feature vectors as input and retrieves sales history features from the product statistics table using the product identifiers.
The server performs data processing by executing queries that obtain fields such as total sales count, recent sales count, and return rate, and normalizing these values (for example, by applying logarithmic scaling or min-max normalization).
The server concatenates the normalized sales features with the evaluation feature vectors to form a composite feature vector for each product.
The server outputs a set of composite feature vectors, one per candidate product, ready for ranking.

### Step 9:

The server inputs the composite feature vectors into a ranking module, which may be implemented as a feed-forward neural network or as a weighted scoring function.
The server performs data processing by, in the case of a neural network, computing successive linear transformations and nonlinear activations to produce a single scalar recommendation score per product, or, in the case of a weighted sum, multiplying each feature by a predetermined coefficient and summing the results.
The server uses the computed scores as composite evaluation values, indicating the recommendation degree for each product.
The server outputs a ranked list of candidate products by sorting the products in descending order of their composite evaluation values.

### Step 10:

The server takes the ranked list and associated feature data as input to a prompt construction module.
The server generates textual descriptions of the user context (event type, budget, recipient attributes), summarized product attributes, and key evaluation features (for example, “high positive sentiment,” “frequently mentioned as ideal for Mother's Day,” “strong recent sales”).
The server performs data processing by assembling these elements into a coherent prompt sentence with instructions for a generative AI model, including explicit segments for user input, product summaries, and generation tasks.
The server outputs a prompt sentence such as:
“User input: I am looking for a Mother's Day present for my mother, budget around 50 dollars.
Context: You are an assistant that recommends gift items based on user reviews and sales data.
Products and analysis (summarized):
Product A: high positive sentiment, frequently mentioned as ideal for Mother's Day, strong recent sales.
Product B: moderate sentiment, some mentions of suitability as a gift, stable sales.
Task: Please recommend the top 3 products for this user, and for each product, provide a concise explanation that references sentiment trends, mentions of ‘Mother's Day,’ and sales performance.”

### Step 11:

The server uses the prompt sentence as input to a generative AI model implemented as a neural network (for example, a decoder-only transformer).
The server performs data processing by tokenizing the prompt sentence, mapping tokens to embeddings, and processing them through successive self-attention and feed-forward layers to compute context-aware hidden states.
The server then performs autoregressive decoding, iteratively generating output token probabilities, selecting tokens according to a decoding strategy (such as greedy decoding or beam search), and updating the context until a termination condition is met.
The server outputs a natural language text sequence that includes recommendations and explanatory text, such as a list of suggested products with reasons referencing sentiment and sales data.

### Step 12:

The server uses the generated natural language output and the internal ranked list as input to a post-processing module.
The server parses the generated text to identify references to specific products, using product names, identifiers, or relative positions, and aligns these references with the ranked candidate products.
The server performs data processing by constructing a final recommendation set that pairs each selected product with a generated explanation and any additional computed metrics (for example, composite evaluation value or confidence level).
The server outputs a structured response object that contains the final recommended products, their attributes, and the associated explanatory texts.

### Step 13:

The terminal receives the structured response object from the server as input.
The terminal parses the object to extract product identifiers, names, images, prices, ratings, and explanatory texts.
The terminal performs data processing by mapping product identifiers to any locally cached images, arranging the products in the recommended order, and formatting the explanatory text for display.
The terminal outputs a rendered user interface on the display, showing the recommended products with explanations, and allows the user to interact further by selecting a product or refining the request.

### Step 14:

The user views the recommended products and their explanations on the terminal and selects one or more products for further inspection or for purchase.
The terminal receives the user's selection as input and constructs a follow-up request containing the selected product identifier and any additional user commands.
The terminal performs data processing by packaging the follow-up request and sending it to the server, or by updating the local UI state if detailed information is already available.
The terminal outputs updated display content, such as detailed product information or confirmation of an added item, thereby completing a cycle of interaction based on the outputs of the generative AI model and the underlying ranking computations.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented recommendation systems for selecting items such as gifts typically rely on manually designed rules, static filtering logic, or simple collaborative filtering based on past purchases and ratings. These systems generally treat user input as a set of keywords and do not fully exploit natural language input, contextual dialogue history, or rich evaluation text such as free-form reviews. As a result, such systems often fail to correctly interpret nuanced user needs, recipient attributes, and constraints (for example, budget, skill level, or usage context), and thus produce suboptimal or generic recommendations.

Furthermore, although generative AI models have emerged as powerful tools for natural language understanding and generation, typical integrations of such models into recommendation workflows are ad hoc. Existing systems frequently invoke a generative AI model only to generate free-form recommendation text after the candidate items have already been selected by conventional algorithms. In such configurations, the generative AI model is not used in a structured way to derive machine-usable intent information, to synthesize evaluation data, or to refine search conditions over item databases. Consequently, the underlying computation performed by the computer remains largely unchanged, and the overall system may not achieve substantial improvements in recommendation accuracy, ranking robustness, or adaptability to iterative user interactions.
Additionally, many existing systems do not effectively combine heterogeneous data sources, such as structured sales performance data, numerical rating scores, and unstructured evaluation text, into a unified, machine-optimized decision pipeline. In particular, unstructured review text is often ignored or only superficially summarized for human consumption, without being systematically integrated into the ranking logic or feedback loop that governs candidate selection. This separation leads to underutilization of data and to recommendation processes that are not resilient to sparse ratings, temporal changes in popularity, or context-dependent quality indicators found only in text.
Moreover, conventional dialog-based recommendation systems typically perform each recommendation cycle independently, without maintaining and exploiting a coherent, updated representation of the user's evolving request content and constraint conditions. As the user refines or adds information over multiple turns of interaction, prior systems may either re-run simplistic keyword matching or rely on brittle session state handling, which can lead to inconsistent or incoherent recommendations, redundant questions, and inefficient computation.
Accordingly, there is a need for an improved computer-implemented recommendation technique that (i) systematically uses generative AI models through well-structured prompt sentences to extract intent and recipient attributes from natural language input, (ii) tightly integrates such extracted information with database-level search and ranking based on sales and evaluation data, (iii) exploits evaluation text via machine-usable summaries and composite statistical indices, and (iv) maintains and updates user request content information and constraint condition information over a dialogue history. Such a technique should improve the operation of the computer itself by orchestrating multiple calls to a generative AI model and conventional data processing modules into a unified pipeline that produces more accurate, robust, and context-aware item recommendations with reduced need for manual rule design.

The specific processing by the specific processing unit 290 of the data processing device 12 in Example 2 is realized by the following means.

The present invention provides a server comprising a processor configured to receive user input information expressed in natural language via a terminal, to construct structured prompt sentences including the user input information and dialogue history, and to transmit the prompt sentences to a generative AI model so as to obtain machine-usable domain information and recipient attribute information corresponding to the user input, the processor further being configured to generate database search conditions based on the domain information and the recipient attribute information, to acquire candidate item information from a storage device that stores item information, sales performance information, and evaluation information, to compute an integrated evaluation index for each candidate item using a statistical method that combines evaluation score information, review count information, and time-series sales performance information, to construct additional prompt sentences including evaluation text information and to transmit the additional prompt sentences to the generative AI model so as to obtain advantage information and disadvantage information for each candidate item, to rank the candidate items based on the integrated evaluation index and the advantage information and the disadvantage information and select optimal candidate item information, and to update user request content information and constraint condition information based on an input history and the dialogue history and to generate further prompt sentences including the updated information so as to cause the generative AI model to generate proposal content in natural language relating to the optimal candidate item information and transmit the proposal content to the terminal for display. This enables an improved computer-implemented recommendation process in which the server orchestrates iterative interactions between structured prompt-based generative AI processing and database-level statistical analysis, thereby enhancing the precision, robustness, and context sensitivity of item selection and ranking, while efficiently adapting to evolving user requirements over multi-turn dialogues.

The term “processor” refers to a hardware or virtual information processing unit, such as a central processing unit or a group of processing cores, that executes machine-readable instructions to perform the functions described in the claims.

The term “terminal device” refers to an electronic apparatus operated by a user, such as a computing device with a display and an input interface, that is configured to transmit user input to the server and to receive and present proposal content generated by the server.
The term “user input information” refers to information expressed in natural language by a user, including but not limited to free-form text describing desired items, recipient characteristics, usage scenarios, constraints, and other preferences.
The term “natural language” refers to a human language, such as a spoken or written language used for everyday communication, as distinguished from formal programming languages or structured query languages.
The term “prompt sentence” refers to a machine-generated or predefined text sequence or data structure that is provided as input to a generative AI model in order to instruct the generative AI model to perform a specified processing task and to produce a corresponding output.
The term “generative AI model” refers to a machine learning model configured to generate or transform data, such as text, in response to input data including at least one prompt sentence, and that is typically trained on large-scale datasets using techniques such as deep learning.
The term “domain information” refers to information indicating a target field or category of items relevant to a user's request, such as a type of product, service, or usage scenario derived from the user input information.
The term “recipient attribute information” refers to information describing characteristics of an intended recipient of an item, including but not limited to demographic features, interests, skill levels, and relationships to the user.
The term “search conditions” refers to machine-usable parameters, filters, and criteria, such as item categories, rating thresholds, and price ranges, that are used to retrieve candidate item information from an information storage device.
The term “information storage device” refers to a memory or storage subsystem, such as a database system or file system, that stores structured or unstructured data including item information, sales performance information, and evaluation information.
The term “item information” refers to structured data describing items to be recommended, including identifiers, names, categories, prices, and other attributes sufficient for selection and display.
The term “sales performance information” refers to data indicating transaction histories and quantities associated with items, including but not limited to sales counts, sales amounts, and time-series records of sales events.
The term “evaluation information” refers to data representing assessments of items by users or other sources, including numerical evaluation score information and textual evaluation text information such as reviews and comments.
The term “candidate item information” refers to a subset of item information retrieved from the information storage device in accordance with search conditions and considered as candidates for recommendation.
The term “evaluation score information” refers to numerical values associated with items that represent ratings or scores, such as star ratings, preference scores, or similar quantitative evaluation measures.
The term “evaluation text information” refers to natural language text associated with items that describes experiences, opinions, or assessments, including but not limited to reviews, comments, and feedback.
The term “statistical method” refers to a computational procedure that applies statistical techniques, such as averaging, weighting, normalization, and time-series analysis, to one or more datasets in order to derive an integrated evaluation index or other aggregated metric.
The term “integrated evaluation index” refers to a composite numerical indicator computed for each candidate item by combining multiple factors, including evaluation score information, review count information, and sales performance information, to represent an overall quality or suitability of the item.
The term “review count information” refers to data indicating the number of evaluation instances, such as the number of reviews or rating entries, associated with each item.
The term “time-series sales performance information” refers to sales performance information that is associated with time stamps or time intervals, allowing analysis of trends or changes in item popularity over time.
The term “advantage information” refers to machine-generated or machine-usable information representing positive aspects, strengths, or benefits of an item, typically derived by processing evaluation text information with a generative AI model.
The term “disadvantage information” refers to machine-generated or machine-usable information representing negative aspects, weaknesses, or limitations of an item, typically derived by processing evaluation text information with a generative AI model.
The term “ranking” refers to arranging candidate items in an order based on one or more metrics, such as the integrated evaluation index and advantage information and disadvantage information, to establish a priority or preference order for recommendations.
The term “optimal candidate item information” refers to item information corresponding to one or more candidate items that are selected as most suitable for recommendation based on the ranking and other decision criteria.
The term “input history” refers to a record of past user input information provided during one or more interactions with the system, including previous natural language queries and refinements.
The term “dialogue history” refers to a record of past exchanges between the user and the system, including user inputs, system outputs, proposals, and other conversational context.
The term “request content information” refers to structured information representing the user's current needs, preferences, and intended use cases for an item, derived from the user input information and updated using the input history and the dialogue history.
The term “constraint condition information” refers to structured information representing conditions or limits imposed by the user or by the system, including but not limited to budget limits, brand preferences, skill levels, and usage constraints.
The term “proposal content” refers to natural language text describing one or more recommended items, including explanations of suitability and reasons for selection, generated by a generative AI model based on optimal candidate item information and associated contextual information.

In one embodiment, a server executes a recommendation system implemented as software modules running on a general-purpose computing platform. The server includes at least one central processing unit, a main memory, a non-volatile storage device, a network interface, and an operating system. The server is connected via a communication network to a terminal operated by a user. The terminal is, for example, a smartphone, a tablet computer, or a personal computer equipped with a display, an input interface, and a network communication function.

The server executes an application program implemented using, for example, a web framework executed on an operating system such as a general-purpose server operating system. The application program is stored in the non-volatile storage device and loaded into the main memory when executed by the central processing unit. The server further accesses an information storage device implemented as a database management system, such as a relational database system or a document-oriented database system, which is stored on one or more storage devices such as solid-state drives or hard disk drives.
The terminal executes a user interface program, which may be implemented as a web browser rendering web pages delivered from the server using a markup language and a script language, or as a native application implemented for a mobile operating system. The terminal presents an input area where the user is able to input natural language text, and displays recommendation results transmitted from the server.
The server receives input information expressed in natural language from the user through the terminal. The input information includes, for example, descriptions such as “My father likes golf, so I am looking for a golf-related present.” The server stores the received input information in a structured data record in the main memory and, optionally, in the non-volatile storage device as part of an input history associated with a user identifier or session identifier.
The server constructs a prompt sentence intended for a generative AI model. The server generates the prompt sentence by embedding the user's input information and, optionally, the dialogue history into a prompt template stored in the non-volatile storage device. In one example, the server constructs a prompt sentence as follows:
“Analyze the following user input and extract:
1) the main product domain,
2) the recipient,
3) the occasion (if any).
Return JSON-like content with keys: product_domain, recipient, occasion.
User input: ‘My father likes golf, so I am looking for a golf-related present.’”
   The server then transmits this prompt sentence via the network interface to a generative AI model accessible through an application programming interface. The generative AI model is implemented on a remote computing infrastructure that includes multiple processor cores, graphics processing units, and large-capacity memory. The generative AI model is a neural network-based language model that has an encoder-decoder-like transformer architecture with multiple attention layers, feed-forward layers, and embedding layers.
   The server sends the prompt sentence as a sequence of tokens. The generative AI model performs tokenization using a subword encoding scheme, converts the tokens into vector embeddings, and processes the embeddings through a plurality of transformer layers. Each transformer layer executes multi-head self-attention and feed-forward computation using learned weight matrices stored in memory. The model outputs probability distributions over vocabulary tokens, and generates a sequence of tokens representing an answer. The answer includes machine-usable domain information such as “golf-related gift items,” recipient attribute information such as “father who enjoys golf,” and, when present, occasion information.
   The server receives the response text from the generative AI model and parses it using a syntactic or structural parser implemented by the application program. The server converts the response into structured domain information and recipient attribute information stored as fields in a data object in main memory. The server then maps these abstract descriptions to internal category codes stored in the information storage device. For example, the server converts “golf-related gift items” into an internal category code representing a general golf category and, optionally, into subcategories for equipment, accessories, or apparel.
   The server generates search conditions by combining the internal category code with default or user-specified constraints. The search conditions are represented as a structured query object containing fields such as category code, minimum rating threshold, price range, and availability constraints. The server translates this query object into a database query, such as a structured query language statement, and transmits the query to the information storage device.
   The server retrieves candidate item information, including item identifiers, item names, brands, prices, and links to images, from the information storage device. The server also retrieves sales performance information, including sales counts and time-series sales data, and evaluation information, including evaluation score information and evaluation text information such as user reviews. The server stores the candidate item information and associated evaluation information in memory as a collection of records, for example, as an array or list of item objects.
   The server computes an integrated evaluation index for each candidate item using a statistical method. The server calculates a weighted average rating based on the evaluation score information for each item. The server uses the review count information as a weight to mitigate the influence of items with few ratings. In addition, the server analyzes time-series sales performance information and calculates a popularity index, for example by computing moving averages or exponential smoothing over recent time intervals. The server integrates the weighted average rating and the popularity index using a linear combination or another aggregation function to produce an integrated evaluation index for each item.
   The server generates a second prompt sentence to obtain advantage information and disadvantage information for each candidate item from the generative AI model. The server includes representative evaluation text information in the prompt sentence, for example as follows:
“You are an assistant that summarizes product reviews.
Summarize the key pros and cons of this product.
Output exactly two sections: ‘Pros:’ and ‘Cons:’.
Reviews:
1. ‘Great distance and very comfortable grip. Perfect for intermediate golfers.’
2. ‘Nice feel, but a bit heavy for beginners.’
3. ‘Excellent quality, my father loved it as a birthday gift.’”
   The server sends the second prompt sentence and the associated evaluation text information to the generative AI model. The generative AI model processes the text similarly through its transformer layers, computing contextualized embeddings and generating a structured summary that separates positive aspects and negative aspects of the item. The server receives the generated text, parses it to identify advantage information and disadvantage information, and stores these as additional attributes of the candidate item records.
   The server ranks the candidate items using the integrated evaluation index and the advantage and disadvantage information. In one example, the server calculates a ranking score that combines the integrated evaluation index with a penalty factor derived from the severity of the disadvantage information. The server arrays the candidate item records in descending order of the ranking score and selects one or more top-ranked items as optimal candidate item information.
   The server maintains a dialogue history and an input history for the user. The server updates request content information and constraint condition information whenever additional input is received from the user via the terminal. For example, when the user adds “My budget is under 200 dollars” or “He is a beginner; can you show something lighter?”, the server appends this new information to the dialogue history and updates constraint condition information to reflect a maximum price and a beginner-level recipient attribute. The server constructs further prompt sentences that include both the previous request content and the new constraints, thereby allowing the generative AI model to adjust domain information and attribute information without discarding earlier context.
   The server generates a third prompt sentence to cause the generative AI model to produce proposal content in natural language relating to the optimal candidate item information. An example of this third prompt sentence is:
“The user wrote: ‘My father likes golf, so I am looking for a golf-related present.’
The user also wrote: ‘My budget is under 200 dollars.’
   Based on the following product information, write a concise and friendly gift recommendation in English suitable to show directly to the user.

### Product:

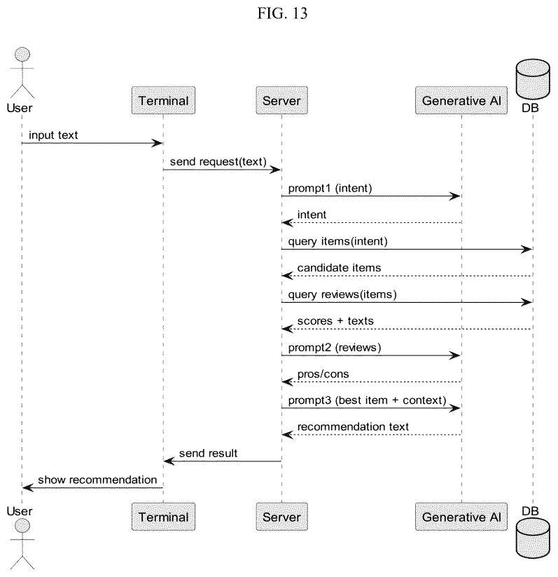

Brand: general-brand
Model: general-model
Category: golf club set
Price: 180 dollars
Average rating: 4.7 out of 5 (200 reviews)
Pros: excellent distance, comfortable grip, good for beginners
Cons: limited color options
Explain briefly why this is a good gift for a father who is a beginner golf player.”
   The server transmits the third prompt sentence and the selected item attributes to the generative AI model. The generative AI model generates proposal content that explains why the selected item is appropriate for the specified recipient and constraints. The server receives the proposal content, stores it in memory, and transmits it to the terminal via the network interface. The terminal displays the proposal content and associated item information such as price, rating, and image.
   By orchestrating multiple prompt sentences and integrating them into the data processing pipeline, the server improves the internal operation of the computer system. The server uses the generative AI model not merely to replace human text writing, but to produce structured, machine-usable domain information, recipient attribute information, and summarized evaluation information that directly modify the search conditions, ranking logic, and selection decisions. This leads to improved precision of item selection, since the search and ranking stages use refined, context-aware information that is not available through simple keyword matching. The server also reduces unnecessary database queries and network traffic by narrowing the search space based on the interpreted intent and constraints, thereby improving processing speed and reducing communication load.
   The generative AI model itself is trained prior to deployment using a large corpus of text data containing product descriptions, reviews, and conversational examples. The training procedure uses a variant of stochastic gradient descent, such as the Adam optimizer, to minimize a loss function based on the difference between the model's predicted tokens and ground-truth tokens in the training data. The model uses multi-head self-attention layers with learned query, key, and value matrices, and position-wise feed-forward layers with non-linear activation functions. During training, the system adjusts the weights in these matrices by computing gradients of the loss function with respect to the weights and updating them iteratively. The training data may be augmented by masking tokens, randomizing order within constraints, or adding synthetic noise to improve robustness.
   In some embodiments, the server employs additional feature engineering for internal ranking.
   The server extracts numerical features such as average rating, review count, recent sales growth, and price, as well as categorical features such as item category and brand. The server may also encode advantage and disadvantage information into feature vectors using a text embedding model. The server then uses these features to compute the integrated evaluation index in a way that balances popularity and quality. This quantitative representation allows the server to perform efficient vector-based computations and to apply non-linear scoring functions that would be difficult for a human operator to manage consistently.
   The server implements data structures optimized for these operations. For example, the server uses an index on category codes and rating thresholds in the database to accelerate retrieval of candidate items. The server uses in-memory hash maps to associate item identifiers with aggregated evaluation statistics and AI-generated summaries. When the user issues frequent refinements of constraints, the server reuses cached results and only recomputes the parts of the ranking that are affected by the new constraints, thereby reducing computational overhead and latency.
   The system produces technical effects beyond mere automation of human judgment. The server can handle larger volumes of candidate items and more complex combinations of evaluation information than a human can manage manually. Because the server integrates neural network-based interpretation with database-level statistical computation, the recommendation pipeline reduces error rates in matching items to nuanced user requirements and adapts to changing user input over multiple turns. The combination of structured prompt design, transformer-based generative processing, and statistical ranking yields increased accuracy and stability in recommendations, while maintaining response times suitable for interactive use.
   The server uses non-conventional procedures that are not equivalent to manual rule creation. For example, instead of predefining static rules for each possible user scenario, the server relies on the generative AI model's learned internal representation of language to infer domain and recipient attributes, and converts the model's outputs into well-defined parameters for search and ranking. This approach allows the server to respond appropriately to previously unseen input patterns while still maintaining deterministic control over database queries and scoring algorithms.
   In alternative embodiments, the server may adjust the architecture of the generative AI model, such as using different numbers of transformer layers, different hidden dimensionalities, or different attention mechanisms. The server may also replace the external network-based generative AI service with a locally hosted generative AI model executed on a specialized hardware accelerator. The overall processing flow remains similar: the server constructs prompt sentences, the model computes contextual embeddings and sequence outputs, and the server derives structured information from the outputs for use in database search and ranking.
   In another embodiment, the server may use additional discriminative models trained on labeled data to predict user satisfaction scores or probability of purchase based on features generated by the generative AI model and statistical metrics. The discriminative model may be a neural network, a gradient-boosted decision tree, or another machine learning model.
   The server uses the discriminative model's output as an additional component of the integrated evaluation index, thereby further improving ranking precision.
   The terminal may be implemented in different forms, such as a desktop computer, a kiosk device, or an in-vehicle information system. The communication between the server and the terminal may use secure communication protocols to protect user input and recommendation data. The user interface may be adapted to different devices but continues to present natural language input fields and item recommendation outputs.
   Through these embodiments, the server, the terminal, and the user cooperate in a system where the server's internal technical processes—prompt sentence construction, generative AI model interaction, structured data mapping, statistical index computation, and ranking—are configured to operate in an integrated manner. This configuration improves computation over large-scale item and evaluation datasets and realizes technical advantages in terms of processing speed, recommendation accuracy, and robustness to evolving user input, beyond what can be achieved by conventional rule-based or keyword-based systems.
   The following describes the processing flow using FIG. 13.

### Step 1:

User operates the terminal to input a request.
User views an input screen on the terminal and types natural language text, for example: “My father likes golf, so I am looking for a golf-related present under 200 dollars.” User then triggers submission (for example, by pressing a send button). As input, the terminal receives raw keystrokes and composes a text string. As output, the terminal generates a structured request message including the text string and metadata (for example, language code and session identifier) and prepares it for transmission to the server.

### Step 2:

Terminal transmits the user request to the server.
Terminal packages the user's text into a data structure, for example a key-value map with fields such as “user_input” and “session_id.” As input, the terminal uses the structured request message from Step 1. The terminal then performs data encoding (for example, UTF-8 encoding) and sends the encoded data over a communication protocol (for example, HTTPS) to the server's network endpoint. As output, the terminal produces a network packet stream addressed to the server.

### Step 3:

Server receives and stores the user input.
Server accepts the incoming network packets and reconstructs the request message. As input, the server receives the encoded data stream from the terminal. The server decodes the data, parses the structure (for example, a JSON body), and extracts fields such as the natural language user input and the session identifier. The server performs data logging and stores the extracted values into an in-memory record and optionally into persistent storage as part of an input history. As output, the server creates a normalized internal representation of the user request.

### Step 4:

Server constructs a first prompt sentence for intent extraction.
Server generates a prompt sentence to instruct the generative AI model to analyze the user's intent. As input, the server uses the normalized user request, including the natural language text and any available dialogue history. The server fills placeholders in a predefined prompt template with the user's text. For example, the server constructs a prompt sentence such as:
“Analyze the following user input and extract:
1) the main product domain,
2) the recipient,
3) the occasion (if any),
4) any explicit constraints such as budget or skill level.
Return JSON-like content with keys: product_domain, recipient, occasion, constraints.
User input: ‘My father likes golf, so I am looking for a golf-related present under 200 dollars.’”
   The server performs string concatenation and formatting to produce a single continuous text sequence. As output, the server produces a first prompt sentence ready to be submitted to the generative AI model.

### Step 5:

Server sends the first prompt sentence to the generative AI model and obtains structured intent.
Server transmits the first prompt sentence to the generative AI model through an application programming interface. As input, the server uses the text of the first prompt sentence. The server calls a client library or HTTP interface, which converts the text into tokens and forwards them to the model service. The generative AI model processes the tokens with its internal neural network, performing attention and feed-forward computations to infer semantic content. The model generates an output text that encodes domain information, recipient attribute information, occasion information, and constraint information in a pseudo-structured form. The server receives this output and parses it (for example, by locating key tokens and splitting key-value pairs). As output, the server produces a structured intent object containing fields such as product domain (“golf-related items”), recipient (“father who enjoys golf”), occasion (“unspecified present”), and constraints (“budget under 200 dollars”).

### Step 6:

Server maps intent information to internal category codes and search parameters.
Server converts the abstract domain and recipient information into internal control data for database search. As input, the server uses the structured intent object from Step 5. The server consults a mapping table or configuration structure that links descriptive phrases (for example, “golf-related items”) to category codes and subcategory codes used in the product database. The server also transforms the budget text (“under 200 dollars”) into numerical ranges and converts recipient attributes (for example, “beginner” if specified) into feature flags. The server performs data mapping and normalization, such as unit conversion and threshold computation. As output, the server produces a search condition object that contains a category code, a price limit, optional skill-level flags, and a minimum rating threshold.

### Step 7:

Server queries the product database for candidate items using structured search conditions.
Server issues a database query based on the search condition object. As input, the server uses the category code, price range, and any additional constraints (for example, minimum rating).
The server builds a database query expression (for example, SQL or a query document) that filters items by category and constraints. The database engine performs index lookups and table scans to retrieve matching records. The server receives the result set containing candidate item records, each with fields such as item identifier, name, brand, price, and category. As output, the server produces a collection of candidate item information records stored in memory.

### Step 8:

Server retrieves evaluation scores and review texts for candidate items.
Server enriches the candidate items with evaluation data. As input, the server uses the list of candidate item identifiers from Step 7. The server constructs a query to a review or statistics table to obtain evaluation score information (for example, average rating, rating distribution) and evaluation text information (for example, review comments). The database engine aggregates scores and returns raw review rows. The server groups and associates the reviews with their respective items by matching identifiers, and the server computes simple aggregates such as the number of reviews per item. As output, the server produces extended candidate item records that include numerical score data, review count data, and collections of review texts.

### Step 9:

Server calculates an integrated evaluation index using statistical methods.
Server computes a composite score for each candidate item. As input, the server uses, for each item, average rating, number of ratings, and time-series sales performance data obtained from the database. The server applies statistical operations: the server calculates a weighted average rating where the weight depends on the number of reviews, and the server computes a popularity index by analyzing time-series sales (for example, recent sales summed or smoothed over a defined time window). The server then combines these values using a scoring formula, such as a linear combination or Bayesian adjustment. As output, the server stores an integrated evaluation index for each candidate item, appended to the candidate item record.

### Step 10:

Server constructs a second prompt sentence to summarize evaluation texts.
Server prepares a prompt sentence for the generative AI model to summarize user reviews.
As input, the server uses evaluation text information for each item, such as a subset of representative review comments selected by sampling or by highest relevance. The server embeds these texts into a summary template. For example, for one item, the server constructs:
“You are an assistant that summarizes product reviews.
Summarize the key pros and cons of this product.
Output exactly two sections: ‘Pros:’ and ‘Cons:’.
Reviews:
1. ‘Great distance and very comfortable grip. Perfect for intermediate golfers.’
2. ‘Nice feel, but a bit heavy for beginners.’
3. ‘Excellent quality, my father loved it as a birthday gift.’”
   The server may batch multiple items or process them sequentially. As output, the server generates a second prompt sentence (or multiple second prompt sentences) containing review text for submission to the generative AI model.

### Step 11:

Server transmits the second prompt sentence to the generative AI model and acquires advantage and disadvantage information.
Server sends the second prompt sentence to the generative AI model to obtain structured summaries. As input, the server uses the second prompt sentence(s) from Step 10. The generative AI model applies its internal attention-based computation to capture sentiment and salient aspects from the review texts and outputs a text summary comprising pros and cons.
The server receives this text and parses the sections labeled “Pros:” and “Cons:” by splitting lines or markers. The server encodes each listed advantage and disadvantage as a simple string or as features (for example, “comfortable grip,” “too heavy for beginners”). As output, the server augments each candidate item record with advantage information and disadvantage information derived from the model output.

### Step 12:

Server ranks candidate items and selects optimal items.
Server generates a ranking based on combined quantitative and qualitative factors. As input, the server uses the integrated evaluation index from Step 9 and the advantage and disadvantage information from Step 11. The server may compute a penalty factor for negative aspects (for example, frequent mentions of “too heavy” for a beginner recipient) and adjust the integrated index accordingly. The server then sorts the candidate items by the resulting ranking score and selects the top one or more items as optimal candidate item information. As output, the server produces a prioritized list of one or more items designated for recommendation, each with full attribute, evaluation, and summary data.

### Step 13:

Server updates request content information and constraint condition information based on history.
Server maintains a dynamic representation of the user's needs over time. As input, the server uses the original user input, any previous turns of dialogue, and the current structured intent object. The server appends new information, such as additional constraints or clarifications, to a dialogue history stored in memory. The server then derives updated request content information (for example, “gift for father who likes golf”) and updated constraint condition information (for example, “budget under 200 dollars, beginner level, prefers light clubs”).
The server performs data merging and rule-based normalization to avoid contradictions and to prioritize the most recent constraints. As output, the server stores revised request content information and constraint condition information, ready to be used for subsequent queries or refinements.

### Step 14:

Server constructs a third prompt sentence for generating proposal content.
Server assembles a prompt sentence that instructs the generative AI model to produce a user-facing recommendation. As input, the server uses the optimal candidate item information selected in Step 12 and the updated request content and constraints from Step 13. The server includes key item attributes (for example, brand, model, category, price, ratings, pros, cons) and the user's profile in the prompt. An example of the third prompt sentence is:
“The user wrote: ‘My father likes golf, so I am looking for a golf-related present under 200 dollars.’
   Based on the following product information, write a concise and friendly gift recommendation in English suitable to show directly to the user.
Product:
Brand: general-brand
Model: general-model
Category: golf club set
Price: 180 dollars
Average rating: 4.7 out of 5 (200 reviews)
Pros: excellent distance, comfortable grip, good for beginners
Cons: limited color options
   Explain briefly why this is a good gift for a father who is a beginner golf player.”
   As output, the server generates a third prompt sentence that encapsulates the context and item details for the generative AI model.

### Step 15:

Server transmits the third prompt sentence to the generative AI model and receives proposal content.
Server sends the third prompt sentence to the generative AI model to obtain final recommendation text. As input, the server uses the third prompt sentence from Step 14. The generative AI model processes the prompt and generates natural language text tailored to the user's situation and the item data. The server receives the generated text and treats it as proposal content. The server may perform post-processing such as trimming extra whitespace or validating that no disallowed tokens are present. As output, the server obtains finalized proposal content associated with the selected item or items.

### Step 16:

Server formats and transmits recommendation data to the terminal.
Server prepares a structured response message for the terminal. As input, the server uses the proposal content from Step 15, together with the optimal item attributes, such as name, price, rating, and image links. The server organizes these into a response structure with fields for display text, item metadata, and optional tracking identifiers. The server then encodes the structure into a format suitable for network transmission and sends it via the communication network to the terminal. As output, the server produces a network response carrying the full recommendation information.

### Step 17:

Terminal receives, decodes, and displays the recommendation.
Terminal accepts the incoming response from the server and reconstructs the structured data.
As input, the terminal uses the encoded response message received over the network. The terminal decodes the message, parses the structure, and extracts the proposal content and item attributes. The terminal updates its user interface by rendering the proposal text in a designated area and displaying the item information with formatted price, rating, and image.
As output, the terminal presents a visual recommendation to the user, enabling the user to understand the suggested item and optionally perform further actions such as viewing details or initiating a purchase.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional recommendation systems and dialog-based support systems that operate on networked computers typically rely on static rules, simple collaborative filtering, or shallow keyword matching. Such systems are limited in their ability to accurately interpret free-form natural language input from users, to detect the nuanced emotional state of the user, and to integrate large volumes of heterogeneous data such as transaction histories and textual evaluation comments. As a result, the systems frequently produce generic or poorly targeted recommendations, require extensive manual feature engineering, and do not fully leverage modern generative artificial intelligence models.

In particular, existing computer-implemented systems exhibit at least the following technical problems.
First, a processing unit often treats user input text, transaction history, and evaluation comments as separate data streams, without a unified representation of “need information” and “emotion information.” This fragmented handling prevents the processor from efficiently performing downstream computations, such as relevance scoring and ranking, and leads to suboptimal memory access patterns and increased computational overhead.
Second, known systems do not systematically convert the intermediate analysis results—such as extracted needs, detected emotions, and aggregated evaluation statistics—into a structured context that can be directly used to construct high-quality prompt sentences for a generative artificial intelligence model. Without such structured context and prompt optimization, the interaction between the recommendation engine and the generative model is ad hoc, unstable, and difficult to scale, resulting in increased latency and reduced consistency of the generated outputs.
Third, conventional systems typically do not apply natural language processing techniques to evaluation comments at scale to derive item-level aggregated evaluation information that captures feature terms, polarities, and aspects. Consequently, the processor cannot compute a robust degree of suitability for each candidate item, especially when cross-referencing the suitability with a user's current emotional state, and thus cannot efficiently narrow the candidate set before involving a computationally expensive generative model.
Fourth, many systems lack a feedback-driven mechanism that automatically updates internal weighting parameters and prompt construction logic based on user interactions with proposed recommendations. In the absence of such adaptive refinement, the system fails to improve over time, and the processor must repeatedly perform similar computations without learning from prior outcomes, which degrades both computational efficiency and recommendation quality.
Accordingly, there is a need for an improved computer-implemented system and processing method in which a processor (i) extracts structured need information and emotion information from natural language user input, (ii) integrates such information with transaction history and evaluation comments in a relational data storage, (iii) computes a degree of suitability for candidate items and selects a recommendation candidate set, and (iv) generates optimized prompt sentences that convey compact, task-specific context to a generative artificial intelligence model. Such a system should further (v) use user interaction history to automatically adapt suitability calculations and prompt construction, thereby enhancing the overall performance, scalability, and technical reliability of the computer-based recommendation engine.

The specific processing by the specific processing unit 290 of the data processing device 12 in Application Example 2 is realized by the following means.

The present invention provides a server comprising a processor configured to receive, via an information processing apparatus, request information expressed in natural language from a user; preprocess the request information and generate need information including at least a requested object, a target person, occasion information, and constraint conditions by performing linguistic analysis on the request information; execute emotion analysis processing on the request information and identify emotion information including at least an emotion type and an emotion intensity; generate search terms based on the need information and the emotion information, and acquire candidate item information by querying a relational data storage that stores transaction history information and evaluation information; apply a natural language processing technique to evaluation comments corresponding to the candidate item information, extract feature terms, evaluation polarity, and evaluation aspects from the evaluation comments, and generate aggregated evaluation information on an item basis; calculate a degree of suitability for each candidate item based on the need information, the emotion information, the candidate item information, and the aggregated evaluation information, and select a recommendation candidate set by applying weighting in accordance with a state of the user; format context information including at least the request information, the need information, the emotion information, and the recommendation candidate set into a text form, and generate a prompt sentence that instructs a generative artificial intelligence model to perform analysis or proposal generation; transmit the prompt sentence to the generative artificial intelligence model and obtain a recommendation content text from the generative artificial intelligence model; associate the recommendation content text with the recommendation candidate set, convert the associated result into presentation information, and transmit the presentation information to the information processing apparatus for presentation to the user; and optionally store history information representing user interactions with the recommendation candidate set and update at least one of weighting parameters used for calculating the degree of suitability and constituent elements of the prompt sentence based on the history information. This enables the server to technically improve the operation of the recommendation system by unifying natural language understanding, emotion-aware scoring, and data-driven prompt generation into a coherent processing pipeline, thereby reducing computational redundancy, increasing the precision and stability of outputs from the generative artificial intelligence model, and adaptively enhancing recommendation quality and system efficiency over time.

The term “processor” refers to a hardware or virtual computing element, such as a central processing unit or processing circuitry executed by a computing platform, that is configured to execute instructions to perform the functions described herein.

The term “information processing apparatus” refers to a user-side computing device, such as a terminal, client device, or communication endpoint, that is configured to transmit request information to, and receive presentation information from, the system.
The term “request information” refers to information expressed in natural language and input by a user to indicate at least one of a desired object, a desired service, an intended recipient, an occasion, or constraints relating to a recommendation.
The term “natural language” refers to a human language used in everyday communication, expressed as text or transcribed speech, and not limited to a predefined command syntax.
The term “need information” refers to structured data derived from the request information, including at least a requested object, a target person, occasion information, and constraint conditions, that is suitable for computational processing and matching with candidate items.
The term “requested object” refers to an item category, product category, service category, or functional requirement indicated by the user as a target of recommendation.
The term “target person” refers to an intended recipient or beneficiary of an item or service to be recommended, including the user and any other person or entity identified in the request information.
The term “occasion information” refers to data representing an event, situation, or context, such as a holiday, celebration, or personal milestone, for which a recommendation is sought.
The term “constraint conditions” refers to additional requirements or preferences, such as budget, style, category limitations, or timing, that restrict or guide the selection of candidate items.
The term “emotion information” refers to structured data representing an estimated emotional state of the user, including at least an emotion type and an emotion intensity derived from the request information.
The term “emotion type” refers to a classification of a user's emotional state, such as happiness, sadness, stress, excitement, or neutrality, identified through emotion analysis processing.
The term “emotion intensity” refers to a quantitative or qualitative measure indicating a strength or degree of an emotion type associated with the user's state.
The term “emotion analysis processing” refers to computational processing that analyzes natural language text to estimate emotion information, including at least one of sentiment scoring, emotion classification, and magnitude estimation.
The term “search terms” refers to one or more keywords, key phrases, or query expressions generated from the need information and the emotion information for use in querying a data storage.
The term “relational data storage” refers to a data storage system organized according to a relational model, such as a relational database, that stores data in tables with rows and columns and supports structured queries.
The term “transaction history information” refers to data describing past transactions involving items or services, including at least information such as item identifiers, quantities, timestamps, and associated user or recipient attributes.
The term “evaluation information” refers to data representing user evaluations of items or services, including at least numeric ratings, textual evaluation comments, or other feedback indicators.
The term “candidate item information” refers to data records retrieved from the relational data storage based on the search terms, representing items or services that satisfy at least some of the need information and are potential recommendations.
The term “evaluation comments” refers to natural language text provided by users or purchasers that expresses opinions, feedback, or experiences regarding items or services.
The term “natural language processing technique” refers to a computational method or algorithm configured to analyze and derive structured information from natural language text, including at least tokenization, parsing, entity extraction, sentiment analysis, or topic extraction.
The term “feature terms” refers to words or phrases extracted from evaluation comments or other text that denote characteristics, attributes, or aspects of an item or service.
The term “evaluation polarity” refers to a classification or score indicating whether an evaluation comment or portion thereof expresses a positive, negative, or neutral opinion with respect to an item or service.
The term “evaluation aspects” refers to specific attributes or dimensions of an item or service, such as quality, appearance, usability, comfort, or durability, that are identified in evaluation comments.
The term “aggregated evaluation information” refers to evaluation-related data generated on a per-item basis by aggregating feature terms, evaluation polarity, and evaluation aspects across multiple evaluation comments for the item.
The term “degree of suitability” refers to a computed score or metric that quantitatively represents how well a candidate item matches the need information and the emotion information of the user.
The term “recommendation candidate set” refers to a subset of candidate items selected based on the degree of suitability and weighting applied according to the state of the user.
The term “state of the user” refers to a condition of the user inferred from at least one of the need information, the emotion information, and interaction history, including emotional tendencies or preference tendencies relevant to recommendation.
The term “context information” refers to combined information that includes at least the request information, the need information, the emotion information, and the recommendation candidate set, formatted to be provided as input to a generative artificial intelligence model.
The term “prompt sentence” refers to a text-form instruction or input sequence that encodes the context information and directs a generative artificial intelligence model to perform analysis, selection, or proposal generation.
The term “generative artificial intelligence model” refers to a computational model that, in response to input data such as a prompt sentence, generates text or other content by probabilistic or learned sequence generation.
The term “recommendation content text” refers to text generated by the generative artificial intelligence model that describes recommended items, reasoning for selection, or other guidance for the user.
The term “presentation information” refers to data derived from at least the recommendation candidate set and the recommendation content text that is formatted for display or output by the information processing apparatus.
The term “history information” refers to data representing user interactions with recommendations, including at least selection operations, evaluation operations, or navigation behavior with respect to presented items.
The term “weighting parameters” refers to one or more adjustable coefficients or factors used in calculating the degree of suitability or in ranking candidate items, which can be updated based on history information.
The term “constituent elements of the prompt sentence” refers to structural components or content elements of a prompt sentence, including selected portions of need information, emotion information, candidate item summaries, and instruction phrases, that determine how information is provided to the generative artificial intelligence model.

In one embodiment, a server, a terminal, and a user cooperate to implement the claimed system. The server executes one or more programs on processing circuitry such as a central processing unit, a graphics processing unit, or a neural network accelerator. The server is connected to one or more storage devices, for example a relational database system, and to a network interface. The terminal is a general-purpose computing device such as a smartphone, tablet, or personal computer running a web browser or native application. The user operates the terminal to input natural language requests and to view recommendation results.

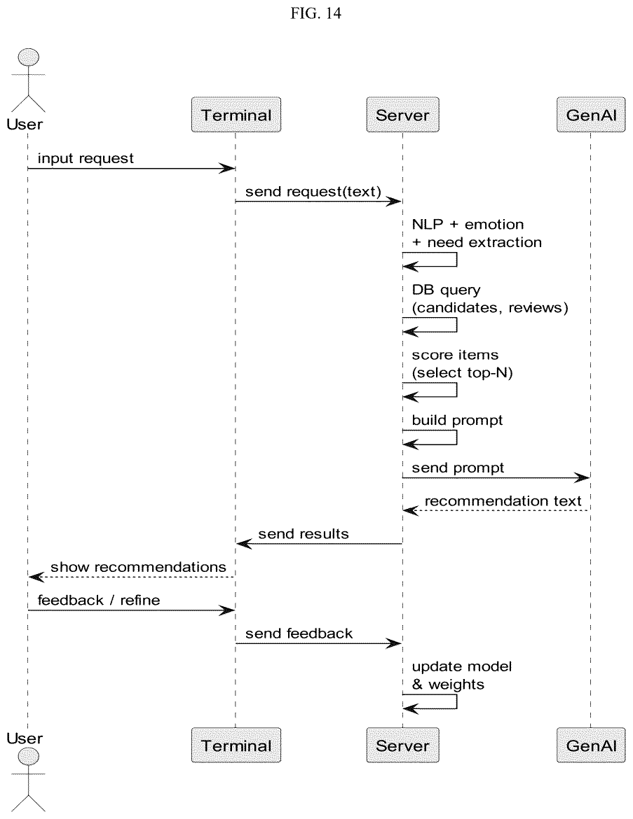

The server stores program modules including at least a natural language preprocessing module, an emotion analysis module, a keyword generation module, a database access module, an evaluation aggregation module, a suitability scoring module, a prompt generation module, and an interface module to a generative AI model. The server implements these modules using a general-purpose programming language, for example a scripting language, and machine learning libraries such as a numerical computation framework, a natural language processing library, and a deep learning framework. The server also maintains a relational database, for example implemented by a relational database management system, which stores transaction history information, evaluation information, and item master information in normalized tables with primary keys and foreign keys.
The server uses the natural language preprocessing module to transform unstructured request information into structured need information. The server applies tokenization, part-of-speech tagging, dependency parsing, and named entity recognition to the request information using a language model executed on the processor. The server maps tokens and entities into an internal data structure, for example a record that contains fields such as requested_object, target_person, occasion, and constraints. The server stores this record in the relational database together with a session identifier.
The server uses the emotion analysis module to generate emotion information from the same request information. The server can apply a sentiment classifier implemented as a neural network model, such as a feedforward network or a transformer-based classifier, which has been trained on annotated text data with emotion labels and intensity scores. The server converts the user's text into token IDs using a tokenizer, retrieves embedding vectors from an embedding matrix, and processes the sequence through multiple layers of self-attention and feedforward transformations. The server obtains a final hidden representation and applies a linear layer and a softmax function to output probabilities over emotion types, and also applies a regression head to estimate emotion intensity. The server writes the resulting emotion type and emotion intensity back to the relational database as part of the emotion information.
The server uses the keyword generation module to derive search terms from the need information and emotion information. The server can maintain a mapping from requested_object and occasion to sets of canonical keywords, and can augment these sets using word embeddings derived from training on a large text corpus. The server calculates cosine similarity in the embedding space between candidate terms and seed terms to determine which additional terms to include. The server stores the selected search terms in a data structure, for example a list associated with the current session.
The server uses the database access module to retrieve candidate item information from the relational database. The server executes parameterized queries against tables that store item data, transaction records, and evaluation records. The server filters items based on category, tags, occasion, and any constraint conditions, and orders items using precomputed statistics such as total sales, recent sales, and average rating. The server constructs candidate item records in memory, each including at least an item identifier, category, numeric attributes such as price and rating, and pointers or foreign keys to associated evaluation comments.
The server uses the evaluation aggregation module to process evaluation comments at scale.
The server retrieves evaluation comments for candidate items from the relational database and applies a natural language processing pipeline to each comment. The server detects feature terms using part-of-speech patterns or a sequence labeling model, and determines evaluation polarity and aspects using either rule-based sentiment lexicons or a neural sentiment model. The server aggregates per-comment information for each item by computing, for example, average polarity scores, counts of mentions per aspect (such as “quality”, “design”, “comfort”), and distributions of feature terms. The server writes aggregated evaluation information back to the relational database or caches it in memory indexed by item identifier.
The server uses the suitability scoring module to compute a degree of suitability for each candidate item. The server defines a feature vector for each item that may include: one-hot or embedding-based encodings of requested_object and target_person; numeric representations of emotion type and intensity; item attributes such as rating, price, and sales volume; and statistics from aggregated evaluation information such as sentiment scores and aspect frequencies. The server applies a scoring function, which may be implemented as a linear model or a neural network, to map the feature vector to a scalar suitability score. The server can incorporate user state, such as a long-term preference profile or recent interactions, through additional features. The server then selects a recommendation candidate set by sorting candidate items by suitability score and selecting the top-ranked items under any business or technical constraints.
The server uses the prompt generation module to transform context information into a prompt sentence for a generative AI model. The server builds a textual description that concatenates at least the user's original request information, a summary of the need information, a summary of the emotion information, and a concise summary of each item in the recommendation candidate set. The server truncates or compresses long descriptions using summarization techniques to keep the prompt within length limits of the generative AI model.
The server then appends instruction text specifying what the generative AI model should do, such as selecting items and explaining reasons.
The server can generate prompt sentences such as:
“The user is looking for a new smartwatch. The user's emotion is neutral. Here is a list of candidate smartwatches with ratings and key review comments: [summary of candidate items]. Based on this data, choose the best 3 smartwatches and explain in plain English why each one fits the user's needs.”
“The user says: ‘Recently, work hasn't gone well and I feel down.’ The user wants a gift that helps improve their mood. The user's emotion is ‘sad/down’. Here is a list of high-rated relaxation items (aroma candles, spa gift sets, relaxing music CDs) with review summaries: [summary of candidate items]. Based on this data, propose 3-5 gifts that are likely to comfort the user and explain why.”
“The user is looking for a Mother's Day present for their mother, who likes flowers. The user's emotion is slightly stressed. Here is a list of high-rated Mother's Day products (flower arrangements, spa gift sets, sweets) with review summaries: [summary of candidate items]. Propose several gift ideas that will please the mother and help reduce the user's stress, and explain your reasoning.”
“The user is looking for a golf-related gift for their father. The user's emotion is neutral. Here is a list of golf products (golf balls, gloves, practice tools, lesson vouchers) with transaction and review summaries: [summary of candidate items]. Select the most suitable gifts for a golf-loving father and explain why.”
   The server transmits the prompt sentence to the generative AI model via an application programming interface. The generative AI model is, in one example, a transformer-based language model with multiple self-attention layers, trained using a maximum likelihood objective on large corpora and optionally fine-tuned on recommendation-related tasks. The server sends the prompt as input tokens and receives generated output tokens, which the server converts to the recommendation content text. The server does not rely on the generative AI model to access the full database; instead, the server provides a constrained summary of candidate items. This design reduces the search space for text generation and improves determinism and latency compared to naive free-form generation.
   The server post-processes the recommendation content text by parsing it to identify explicit references to particular items in the recommendation candidate set. The server can use string matching and similarity metrics to align names in the generated text with item identifiers in its data structures. The server then constructs presentation information by combining the generated explanations with item metadata such as images, prices, and availability flags. The server transmits this presentation information to the terminal via a communication protocol. The terminal receives the presentation information and renders it through a user interface. The terminal may display a list of recommended items as cards containing an image, title, rating, and short explanation text from the generative AI model. The user can select one of the recommended items, request additional options, or provide explicit feedback such as “like” or “not helpful”. The terminal transmits user actions back to the server as interaction events.
   The server stores interaction events as history information in the relational database. The server uses the history information to update weighting parameters used in the suitability scoring module. The server can implement a learning procedure in which the suitability model is retrained or fine-tuned with supervised learning, using positive interactions as positive examples and ignored items as negative examples. The server minimizes a loss function such as cross-entropy or mean squared error between predicted suitability and observed user selections, and updates model weights by gradient-based optimization. The server can also adjust the structure of prompt sentences by modifying which fields are included or how they are ordered, based on observed success rates. This adaptive behavior leads to a technical improvement in model accuracy and system efficiency over time. The server thereby achieves several technical effects. Because the server extracts and stores structured need information and emotion information, the server reduces the computational complexity of subsequent operations compared to re-parsing raw text for every query. Because the server computes aggregated evaluation information in advance or incrementally, the server can respond faster to new user requests by using cached statistics rather than processing all evaluation comments each time. Because the server selects a limited recommendation candidate set before invoking a generative AI model, the server reduces the amount of data that must be encoded in the prompt sentence and shortens the processing time of the generative AI model. This reduces communication load between the server and the generative AI model, lowers memory bandwidth usage, and exhibits lower latency. The server improves precision by tightly coupling the generative AI model with structured features such as suitability scores and aggregated evaluation aspects. The server does not merely automate human decision making; instead, the server creates a non-conventional data flow in which the generative AI model is used as a language interface on top of a pre-filtered candidate set, with the underlying relational database and scoring models handling large-scale numeric computation and indexing. This architecture enhances the stability of outputs and mitigates hallucination behaviors common in generic language models, thus improving the reliability of computer-based recommendations.
   The server also employs a non-traditional control loop for prompt construction. The server does not merely forward user text to the generative AI model. The server instead transforms the user's request into internal representations, computes numeric scores and summaries, and then composes a prompt sentence that encodes this information according to system-defined rules. The server can vary the inclusion or exclusion of specific fields, varied weighting language, or explicit ranking criteria in the prompt, and can refine these rules based on system-level performance metrics. Such an approach differs from conventional static prompts, and results in more efficient utilization of the generative AI model and improved end-to-end system throughput.
   In another embodiment, the server can host the generative AI model locally rather than calling an external service. The server can deploy a transformer model with a defined number of layers, hidden dimensions, and attention heads. The server can fine-tune the model using training data that contains examples of input prompt sentences and desired recommendation content texts. The server uses a loss function that combines a standard language modeling loss with a ranking-aware term that encourages correct ordering of items in generated outputs. The server updates the model parameters using batch gradient descent or an adaptive optimization algorithm. This training process allows the server to tailor the generative AI model to the specific domain of recommendation tasks, which further improves generation accuracy and reduces the need for long prompts, thereby saving computational resources. In yet another embodiment, the server can vary the architecture of the suitability scoring module. The server may implement a gradient-boosted decision tree model that utilizes structured features derived from need information, emotion information, transaction history, and aggregated evaluation information. The server can compare the performance and computational cost of such a model against a neural network-based scorer and choose an implementation that balances latency and accuracy. The server can also employ caching strategies where precomputed suitability scores for common occasions are stored, and only incremental adjustments based on current emotion information are computed in real time. The system is not limited to recommending items in a commerce context. The server can also apply the same architecture to recommend services, digital content, or configuration options in a device. For example, the server can recommend relaxation programs for a wellness device, or content playlists for an entertainment system, taking into account the user's emotional state and past usage patterns. In such scenarios, the server can interface directly with device control modules to provision settings or content selections. By controlling device behavior based on computed suitability and emotion information, the server further demonstrates an application that extends beyond abstract data processing into concrete control of physical or digital equipment.
   The terminal, the server, and the generative AI model may be configured in various deployment patterns. The server can be implemented as a single physical machine or as a distributed cluster in a cloud environment, with different modules deployed as microservices. The relational database may be replaced or supplemented by a columnar store or a key-value store for performance. The emotion analysis module may be replaced with alternative machine learning architectures, provided that the module outputs structured emotion information. The generative AI model may be any sequence generation model that accepts prompt sentences and produces coherent text, including but not limited to transformer-based models and recurrent neural network-based models.
   Through these embodiments, the server improves computer technology by defining specific data structures and algorithmic flows that optimize how natural language input, transaction data, and evaluation comments are combined, how a generative AI model is invoked, and how results are adapted based on history. The technical improvements include reduced processing time through pre-aggregation and candidate filtering, improved accuracy through feature-rich suitability scoring and structured prompting, and more efficient communication between modules by limiting and structuring the data passed to the generative AI model.
   The following describes the processing flow using FIG. 14.

### Step 1:

User uses the terminal to access the system and input a request.
User operates an input interface on the terminal, such as a text box in a browser or a native application, and enters request information in natural language (for example, “I am looking for a new smartwatch” or “Recently, work has not gone well and I feel down; please recommend a gift”).
Input: Raw natural language text entered by the user and optional metadata (for example, session ID, language setting).
Output: A request message containing the user's text and metadata, transmitted from the terminal to the server over a network.

### Step 2:

Terminal packages and transmits the request to the server.
Terminal encodes the user's text and metadata into a structured message, for example a JSON object, and sends an HTTP request to an endpoint exposed by the server. Terminal may add device information and time stamps.
Input: User's natural language text and local metadata.
Output: A network-level request payload delivered to the server, containing the request information in a machine-readable format.

### Step 3:

Server receives, validates, and logs the request information.
Server accepts the incoming HTTP request, parses the payload, and verifies that required fields (for example, text, session ID) are present and within size limits. Server then stores the raw request information, time stamp, and session ID in a relational database record.
Input: Network payload from the terminal containing the request information.
Output: A stored request record in the database and an in-memory representation of the request prepared for further processing.

### Step 4:

Server performs natural language preprocessing on the request information.
Server passes the request text to a natural language preprocessing module that performs tokenization, sentence segmentation, part-of-speech tagging, dependency parsing, and named entity recognition. Server converts the sequence of tokens and entities into an internal data structure that captures grammatical roles and candidate concept spans.
Input: Raw request text from the database or in-memory structure.
Output: A parsed text representation including tokens, syntactic relations, and recognized entities, stored in memory for subsequent analysis.

### Step 5:

Server extracts need information from the parsed text.
Server analyzes the parsed representation using rule-based patterns and/or a trained classifier to identify a requested object (for example, smartwatch, Mother's Day gift), a target person (for example, mother, father, self), occasion information (for example, Mother's Day, project success), and constraint conditions (for example, budget, “likes flowers”). Server maps these elements into fields of a need information record.
Input: Parsed text representation from Step 4.
Output: Structured need information containing at least requested_object, target_person, occasion, and constraints, stored as a record associated with the session.

### Step 6:

Server performs emotion analysis to generate emotion information.
Server feeds the original or normalized text into an emotion analysis model, such as a transformer-based classifier. Server converts text tokens to embeddings, processes them through multiple attention layers, and uses output vectors to compute probabilities over emotion types (for example, joy, sadness, stress) and a continuous emotion intensity value.
Server then selects the most probable emotion type and records the corresponding intensity.
Input: Raw or normalized request text and model parameters of the emotion classifier.
Output: Emotion information including emotion_type and emotion_intensity, stored and linked to the current need information and session.

### Step 7:

Server generates search terms from need information and emotion information.
Server uses mappings and embedding-based similarity to convert requested_object, occasion, and relevant constraints into a set of canonical search terms (for example, “smartwatch”, “wearable device”, “fitness tracker”) and, if relevant, emotion-sensitive tags (for example, “relaxation”, “celebration”). Server uses cosine similarity in an embedding space to expand or refine these terms.
Input: Need information record and emotion information from Steps 5 and 6.
Output: A list of search terms and tags suitable for querying the relational database.

### Step 8:

Server queries the relational database to retrieve candidate item information.
Server constructs parameterized SQL queries using the search terms and executes them against tables that store item master data, transaction history, and existing ratings. Server filters by category, occasion tags, and optional constraints, and orders results using basic metrics such as sales volume and average rating.
Input: Search terms and database schema/indices.
Output: A set of candidate item records, each including at least an item identifier, descriptive attributes, ratings, and links to evaluation comments.

### Step 9:

Server retrieves evaluation comments associated with candidate items.
Server uses item identifiers from candidate records to select corresponding evaluation comments from an evaluation table. Server fetches comment text, commenter rating, and time stamps for each candidate item.
Input: Candidate item identifiers from Step 8.
Output: A collection of evaluation comments grouped by item, cached in memory for NLP analysis.

### Step 10:

Server performs natural language processing on evaluation comments to build aggregated evaluation information.
Server processes each evaluation comment through a comment analysis pipeline. Server tokenizes, tags, and labels phrases as aspect terms (for example, “battery life”, “design”, “relaxing aroma”) and computes evaluation polarity scores using a sentiment model. Server then aggregates for each item: average polarity, counts per aspect, and frequently mentioned feature terms.
Input: Raw evaluation comments from Step 9.
Output: Aggregated evaluation information per item, containing feature terms, aspect statistics, and sentiment metrics, associated with each candidate item.

### Step 11:

Server constructs feature vectors and computes a degree of suitability for each candidate item.
Server assembles a numeric feature vector for each candidate item using fields from need information (encoded as one-hot or embeddings), emotion information (for example, emotion type index, intensity), item attributes (for example, price, sales, rating), and aggregated evaluation metrics. Server feeds these vectors into a scoring model, which may be a linear predictor, a neural network, or a tree-based model, and computes a scalar suitability score.
Input: Need information, emotion information, candidate item attributes, and aggregated evaluation information.
Output: A list of candidate items each annotated with a computed suitability score.

### Step 12:

Server selects a recommendation candidate set based on suitability scores and user state.
Server sorts candidate items by suitability score and applies user-state-aware weights (for example, boosting relaxing items when emotion_type is “sad”). Server filters out items that violate constraints (for example, wrong recipient type, out-of-stock flag) and selects the top-ranked subset as the recommendation candidate set.
Input: Candidate items with suitability scores from Step 11 and user state information if available.
Output: A recommendation candidate set, consisting of item identifiers and associated summary attributes prepared for prompt construction.

### Step 13:

Server summarizes context information for prompt generation.
Server constructs concise text summaries for each recommended item, including key attributes such as category, rating, main pros from evaluations, and relevant aspects. Server aggregates need information and emotion information into short descriptive phrases. Server organizes these segments into a structured context ready to be embedded into a prompt sentence.
Input: Recommendation candidate set, need information, and emotion information from previous steps.
Output: Context information in textual form, including item summaries and user context, stored as strings or templates.

### Step 14:

Server generates a prompt sentence for the generative AI model.
Server concatenates the user's original request, summarized need and emotion, and item summaries with explicit instructions describing the desired output format. Server ensures the total length stays within model limits by truncating or compressing less critical parts. Server produces a single prompt sentence or multi-sentence block guiding the generative AI model to select and explain recommendations.
Input: Textual context information from Step 13 and prompt construction rules.
Output: A prompt sentence that encodes instructions and context for the generative AI model.

### Step 15:

Server transmits the prompt sentence to the generative AI model and obtains recommendation content text.
Server sends the prompt sentence to a generative AI model endpoint, converting the text into token IDs if needed. Server receives a sequence of generated tokens from the model and decodes them into natural language text that describes recommended items and reasons for selection.
Input: Prompt sentence from Step 14 and generative AI model parameters/endpoints.
Output: Recommendation content text generated by the generative AI model.

### Step 16:

Server aligns generated text with items in the recommendation candidate set and composes presentation information.
Server parses the recommendation content text to identify item references and explanation segments. Server matches referenced names or descriptions to item identifiers using exact match or similarity scores. Server then constructs presentation records that bind each recommended item to its generated explanation and include metadata such as price, rating, and images.
Input: Recommendation content text from Step 15 and recommendation candidate set from

### Step 12.

Output: Presentation information ready for delivery to the terminal, including item/explanation pairs and display attributes.

### Step 17:

Server transmits presentation information to the terminal.
Server serializes the presentation information into a response message (for example, a structured payload) and sends it over the network to the terminal. Server may also include flags for layout (for example, ranking order, highlight of emotion-sensitive items).
Input: Presentation information from Step 16.
Output: A network response delivering formatted recommendation data to the terminal.

### Step 18:

Terminal renders recommendations to the user.
Terminal receives the response, parses the payload, and constructs visual components such as cards or lists. Terminal displays item images, names, prices, ratings, and the explanation text from the generative AI model. Terminal may highlight certain items based on metadata (for example, “best match” or “good for relaxation”).
Input: Presentation payload from the server in Step 17.
Output: A user interface showing concrete recommended items and textual justifications on the terminal screen.

### Step 19:

User interacts with the recommendations and provides feedback.
User inspects the displayed items, selects one or more for further details or purchase, or indicates preferences such as “this is helpful” or “show more like this”. User may also refine the request by entering additional text (for example, “under 100 dollars” or “more unique items”).
Input: Displayed recommendations and explanations from the terminal.
Output: User interaction events (clicks, selections, evaluations, refined text) captured by the terminal.

### Step 20:

Terminal sends interaction events back to the server.
Terminal records user selections and feedback as structured events and transmits them to the server via a network request. Terminal may batch multiple events to reduce communication overhead.
Input: User interaction events from Step 19.
Output: Event payloads representing history information sent to the server.

### Step 21:

Server logs interaction history and updates adaptive parameters.
Server stores received interaction events as history information linked to items, sessions, and users. Server then uses this history to adjust weighting parameters in the suitability scoring model and to refine prompt construction rules. Server may execute a training or fine-tuning routine in which positive interactions are used as targets to increase predicted suitability for similar feature vectors, while ignored items or negative feedback decrease scores.
Input: Interaction events from Step 20 and current model/prompt parameters.
Output: Updated model weights and prompt construction parameters, and expanded history records in the database, which influence suitability scores and prompt sentences in subsequent executions.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

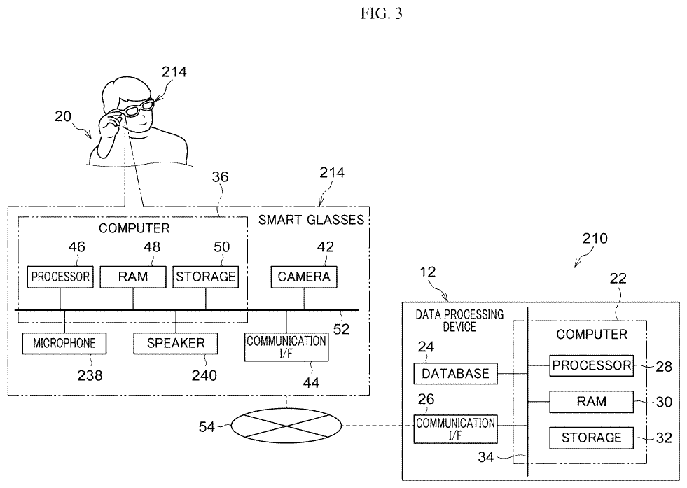

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

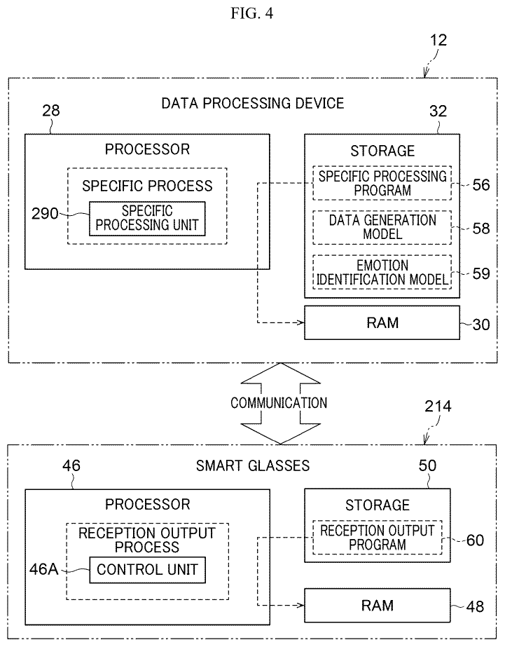

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

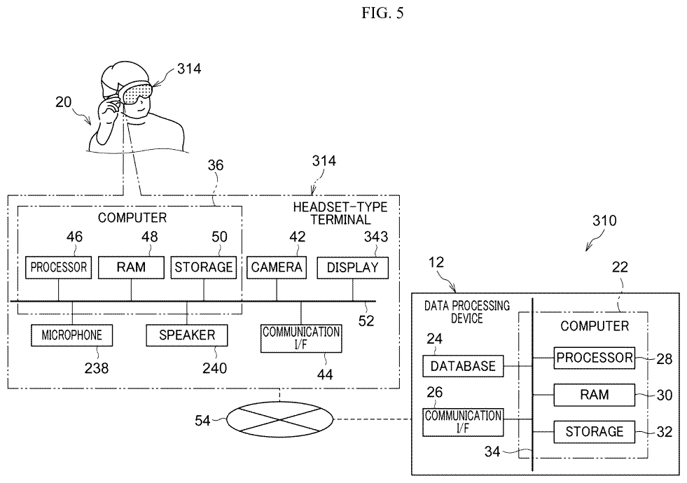

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

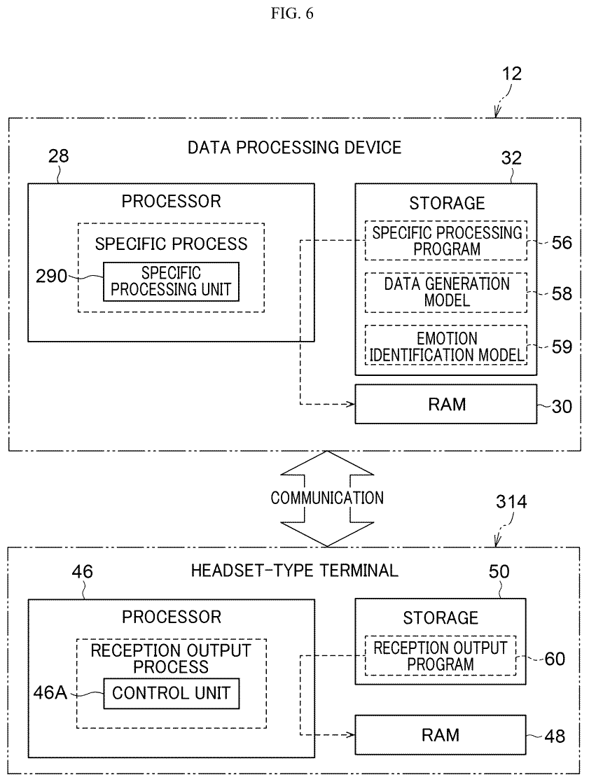

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

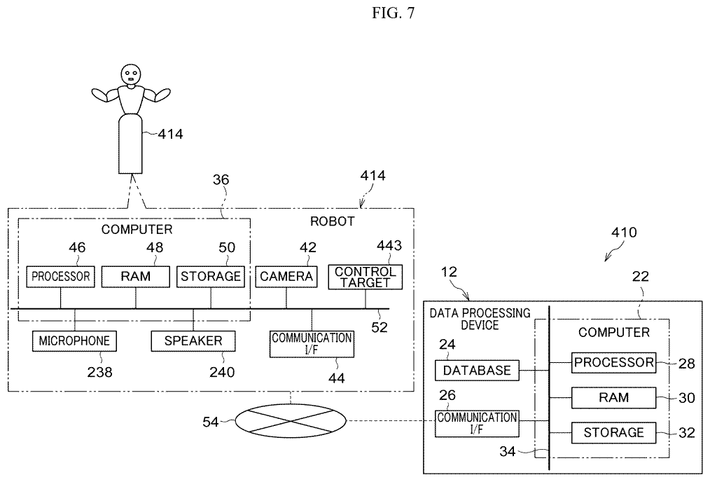

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

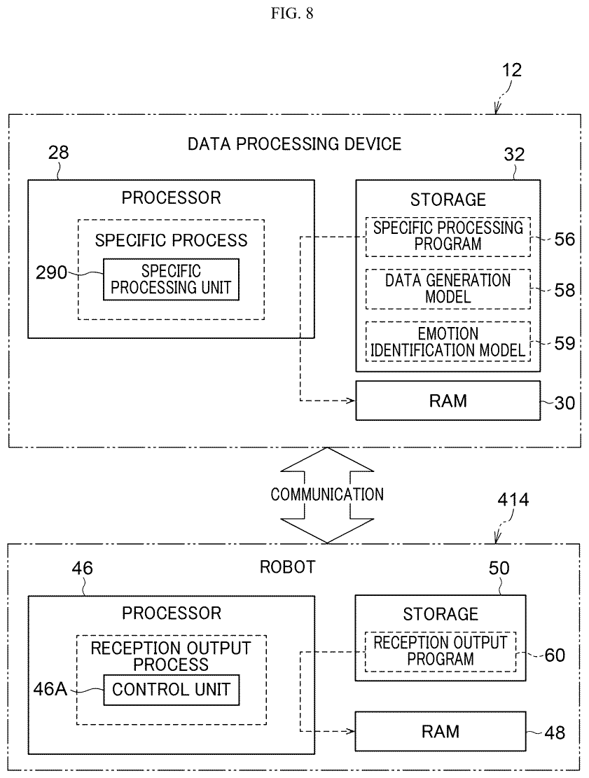

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

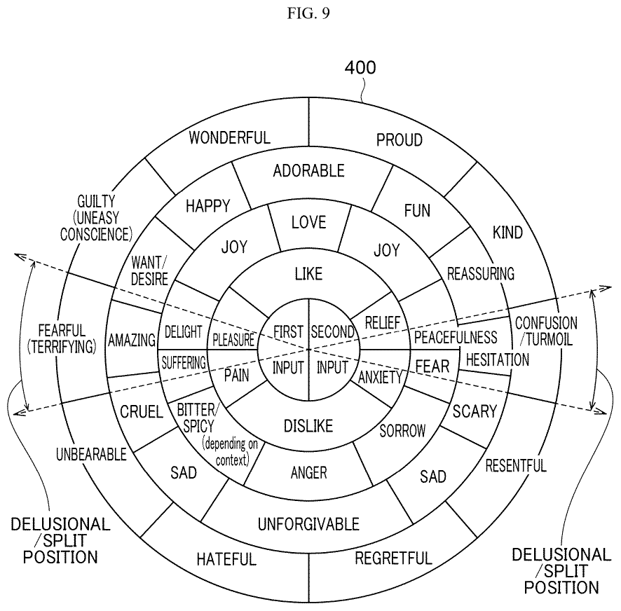

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

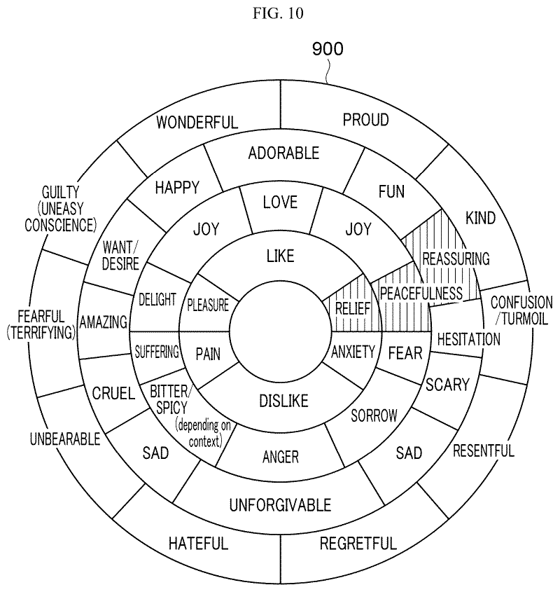

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to receive, via a terminal, a user request expressed in natural language and acquire the request as text information,
generate an analysis prompt sentence including the acquired text information, input the analysis prompt sentence to a generative AI model, and cause the generative AI model to output structured user need information including event information, recipient information, and constraint information,
execute query processing on an information storage device storing transaction history information and evaluation information, based on the structured user need information, and acquire multiple target item pieces of information including sales performance information and evaluation information for a predetermined period,
extract evaluation comments from the acquired target item pieces of information, apply natural language processing to the evaluation comments to perform segmentation and linguistic classification, calculate feature terms and sentiment polarity, and generate feature information and evaluation trend information for each item,
calculate, for each target item, a composite evaluation value by using the generated feature information, the evaluation trend information, and the sales performance information, and select candidate items suitable for the structured user need information by ranking the target items based on the composite evaluation value,
generate a recommendation prompt sentence including information on the selected candidate items and the structured user need information, input the recommendation prompt sentence to the generative AI model, and cause the generative AI model to generate a recommendation sentence in natural language describing the candidate items, and
transmit, to the terminal, response information including the generated recommendation sentence and corresponding candidate item information and cause the response information to be presented to the user via the terminal.

### Supplementary 2

The system according to supplementary 1,
wherein the processor is configured to
apply natural language processing to the evaluation comments to extract feature terms corresponding to attributes of the items, perform aggregation processing of sentiment polarity for each feature term, thereby identify attribute-specific evaluation tendencies for each item, and reflect the attribute-specific evaluation tendencies in the calculation of the composite evaluation value.

### Supplementary 3

The system according to supplementary 1,
wherein the processor is configured to
acquire additional input as question-and-answer data through multiple natural language interactions with the user, generate an updated analysis prompt sentence including the additional input, input the updated analysis prompt sentence to the generative AI model to sequentially extract updated user need information and emotion information, and dynamically adjust the ranking of the candidate items and contents of the recommendation prompt sentence according to the updated user need information and emotion information.

### Application Example 1

### Supplementary 1

A system comprising a processor,
wherein the processor is configured to
receive user input expressed in natural language and convert the user input into structured information including an event type, budget information, and recipient attributes,
retrieve, based on the structured information, product information and past sales history information for candidate gift items from a relational data storage device,
acquire, from the relational data storage device, evaluation comments associated with the candidate gift items and perform preprocessing of the evaluation comments as text data,
input numerical data generated by preprocessing the evaluation comments, including distributional representation conversion, tokenization, and length normalization, into a machine learning model including a natural language processing model, and generate analysis results including an emotion index, an event suitability index, and a topic classification index for the evaluation comments,
integrate the analysis results with the past sales history information and the product information, calculate for each candidate gift item a composite evaluation value indicating a recommendation degree, and rank the candidate gift items based on the composite evaluation value,
generate, based on the user input, the analysis results, and the composite evaluation value, a prompt sentence for causing a generative information processing model to execute input analysis or proposal generation, input the prompt sentence into the generative information processing model, and obtain natural language output including gift recommendation content and explanatory text for the recommendation, and
generate, based on the natural language output and the ranked candidate gift items, a list of candidate gift items and explanatory information to be presented to the user, and present the list and the explanatory information to the user via an output device.

### Supplementary 2

The system according to supplementary 1,
wherein the processor is configured to calculate, by using the machine learning model, for each evaluation comment an emotion score and an event-related score, aggregate the emotion score and the event-related score for each candidate gift item to generate evaluation features including an average value, distribution information, and temporal variation, and calculate the composite evaluation value by using the evaluation features.

### Supplementary 3

The system according to supplementary 1,
wherein the processor is configured to include, in the prompt sentence input to the generative information processing model, structured information summarizing the user input, the evaluation features, the past sales history information, and the composite evaluation value, and to instruct the generative information processing model, by means of the prompt sentence, to generate recommendation text for gift items adapted to user needs and user emotions and explanatory text indicating reasons for selection of each candidate gift item.

### Example 2

### Supplementary 1

A system comprising a processor,
wherein the processor is configured to
receive input information expressed in natural language from a user via a terminal device,
generate a first prompt sentence including the input information, and transmit the first prompt sentence to a generative AI model so as to obtain, from the generative AI model, domain information relating to a target field and attribute information relating to a gift recipient corresponding to the input information,
generate search conditions based on the domain information and the attribute information, and, in accordance with the search conditions, acquire candidate item information from an information storage device that stores item information, sales performance information, and evaluation information,
acquire evaluation score information and evaluation text information corresponding to the candidate item information, calculate, by a statistical method, an integrated evaluation index for each item included in the candidate item information, and generate a second prompt sentence including the evaluation text information and transmit the second prompt sentence to the generative AI model so as to obtain, from the generative AI model, advantage information and disadvantage information for each item included in the candidate item information,
rank the candidate item information based on the integrated evaluation index and the advantage information and the disadvantage information, and select optimal candidate item information,
update request content information and constraint condition information of the user based on an input history and a dialogue history of the user, generate a third prompt sentence including the request content information and the constraint condition information, and transmit the third prompt sentence to the generative AI model so as to cause the generative AI model to generate proposal content expressed in natural language relating to the optimal candidate item information, and
transmit the proposal content to the terminal device for display to the user.

### Supplementary 2

The system according to supplementary 1,
wherein the processor is configured to calculate the integrated evaluation index by calculating a weighted average value based on the evaluation score information and review count information for each item included in the candidate item information, calculating a popularity index based on time-series sales performance information, and integrating the weighted average value and the popularity index.

### Supplementary 3

The system according to supplementary 1,
wherein the processor is configured to generate a further first prompt sentence including additional input information from the user and the dialogue history, transmit the further first prompt sentence to the generative AI model so as to sequentially update the domain information, the attribute information, and the constraint condition information, and, based on the updated information, re-execute generation of the search conditions for the candidate item information, calculation of the integrated evaluation index, and generation of the proposal content.

### Application Example 2

### Supplementary 1

A system comprising a processor,
wherein the processor is configured to
receive, via an information processing apparatus, request information expressed in natural language from a user,
preprocess the request information and generate need information including at least a requested object, a target person, occasion information, and constraint conditions by performing morphological analysis, syntactic analysis, and phrase extraction on the request information,
execute emotion analysis processing on the request information and identify emotion information including at least an emotion type and an emotion intensity,
generate search terms based on the need information and the emotion information, and acquire candidate item information by querying a relational data storage that stores transaction history information and evaluation information,
apply a natural language processing technique to evaluation comments corresponding to the candidate item information, extract feature terms, evaluation polarity, and evaluation aspects from the evaluation comments, and generate aggregated evaluation information on an item basis,
calculate a degree of suitability for each candidate item based on the need information, the emotion information, the candidate item information, and the aggregated evaluation information, and select a recommendation candidate set by applying weighting in accordance with a state of the user,
format context information including at least the request information, the need information, the emotion information, and the recommendation candidate set into a text form, and generate a prompt sentence that instructs a generative artificial intelligence model to perform analysis or proposal generation,
transmit the prompt sentence to the generative artificial intelligence model and obtain a recommendation content text from the generative artificial intelligence model, and
associate the recommendation content text with the recommendation candidate set, convert the associated result into presentation information, and transmit the presentation information to the information processing apparatus for presentation to the user.

### Supplementary 2

The system according to supplementary 1,
wherein the processor is configured to
include, in the prompt sentence to be input to the generative artificial intelligence model, summary information extracted from at least the need information, the emotion information, and the candidate item information, and control the generative artificial intelligence model to perform selection of items among the candidate item information and generation of reasons for the selection based on the prompt sentence.

### Supplementary 3

The system according to supplementary 1,
wherein the processor is configured to
store, as history information, at least one of a selection operation and an evaluation operation performed by the user with respect to the recommendation candidate set, and update weighting parameters used for calculating the degree of suitability of the candidate items and constituent elements of the prompt sentence based on the stored history information.

What is claimed is:

1. A system comprising:
circuitry configured to:
receive, via a communication interface coupled to a packet-switched network, a natural language request from a terminal device;
generate a first prompt sentence encoding the natural language request, and input the first prompt sentence to a generative neural network model to obtain structured need information comprising at least an event identifier, a recipient attribute, and a constraint parameter;
execute query processing on a storage device storing transaction history data and evaluation data based on the structured need information to retrieve a plurality of item records comprising sales performance data and evaluation comment text;
apply natural language processing to the evaluation comment text to perform segmentation and linguistic classification, calculate feature terms and a sentiment polarity value for each item record, and generate feature information and evaluation trend information for each item record;
compute, for each item record, a composite evaluation value based on at least the feature information, the evaluation trend information, and the sales performance data, and rank the item records based on the composite evaluation value to select candidate item records;
generate a recommendation prompt sentence by encoding the structured need information and information on the selected candidate item records, input the recommendation prompt sentence to the generative neural network model to obtain natural language recommendation text describing the candidate item records; and
transmit, via the communication interface, response data comprising the recommendation text and candidate item information to the terminal device.

2. The system according to claim 1, wherein the circuitry is configured to apply the natural language processing to the evaluation comment text by applying a text segmentation algorithm to split the evaluation comment text into sentence-level segments, applying a linguistic classifier to each segment to assign a feature label and a sentiment polarity score, and aggregating the feature labels and sentiment polarity scores to generate the feature information and the evaluation trend information.

3. The system according to claim 2, wherein the circuitry is configured to compute the composite evaluation value by applying a weighted sum of the feature information, the evaluation trend information, and the sales performance data, and to adjust the weights based on the constraint parameter derived from the structured need information.

4. The system according to claim 2, wherein the structured need information further comprises gift-related event information, recipient demographic information, and a budget constraint, and the composite evaluation value incorporates a suitability score reflecting a degree to which each item record satisfies the recipient attribute and the budget constraint.

5. The system according to claim 4, wherein the circuitry is configured to apply a keyword extraction algorithm to the evaluation comment text to identify product characteristic terms and to generate a feature vector for each item record based on the identified characteristic terms, and to compute the suitability score by comparing the feature vector against the recipient attribute using a similarity metric.

6. The system according to claim 1, wherein the circuitry is configured to detect an emotional state of a user from at least one of voice data or text data received from the terminal device, and to adjust the recommendation prompt sentence by incorporating the detected emotional state as an emotion parameter, thereby causing the generative neural network model to adapt a tone and content of the recommendation text to the detected emotional state.

7. The system according to claim 6, wherein the circuitry is configured to apply an emotion identification model to the at least one of voice data or text data to output a probability distribution over a plurality of emotional state categories, and to select a proposal adjustment based on the probability distribution.

8. The system according to claim 1, wherein the circuitry is configured to generate the first prompt sentence by constructing a structured template that encodes the natural language request, and to input the first prompt sentence to the generative neural network model to extract at least the event identifier, the recipient attribute, and the constraint parameter as structured output fields.

9. The system according to claim 8, wherein the circuitry is configured to iterate the first prompt sentence by initiating a dialogue with the user to acquire additional need information when the structured output fields include one or more undefined fields, and to update the structured need information based on the additional need information received from the terminal device.

10. The system according to claim 1, wherein the circuitry is configured to retrieve the item records by executing a structured query against the storage device using the event identifier, the recipient attribute, and the constraint parameter as filter conditions, and to limit the retrieved item records to entries satisfying the constraint parameter.

11. The system according to claim 10, wherein the circuitry is configured to apply a secondary ranking criterion to the ranked item records based on a recency metric derived from the transaction history data, and to select a top-N subset of the ranked item records as the candidate item records for input to the recommendation prompt sentence.

12. The system according to claim 1, wherein the circuitry is configured to store transaction history data comprising past item interactions of the user in the storage device, and to apply a personalization weight to the composite evaluation value based on a frequency of past interactions with items sharing a category identifier with each item record.

13. The system according to claim 12, wherein the circuitry is configured to update the personalization weight after each recommendation session by recording a user selection from the response data as a positive interaction signal and adjusting the frequency metric in the transaction history data.

14. The system according to claim 1, wherein the circuitry is configured to include, in the recommendation prompt sentence, a constraint encoding the event identifier, the recipient attribute, and the budget constraint, and to apply a token-level filter to the natural language recommendation text output by the generative neural network model to verify that the recommendation text does not reference items violating the budget constraint.

15. The system according to claim 1, wherein the circuitry is configured to generate a plurality of recommendation text candidates by executing the generative neural network model a plurality of times using different sampling parameters, score each candidate using the composite evaluation value of the corresponding candidate item records, and select a highest-scoring candidate as the recommendation text for transmission.

16. The system according to claim 1, wherein the circuitry is configured to retrieve, from a vector database, reference documents related to the structured need information using a retrieval-augmented generation architecture, and to incorporate the retrieved reference documents into the recommendation prompt sentence.

17. The system according to claim 1, wherein the circuitry is configured to update evaluation data in the storage device by receiving new evaluation comment text from the terminal device after a completed transaction, applying the natural language processing to the new evaluation comment text to extract updated feature terms and sentiment polarity, and adding the updated feature terms and sentiment polarity to the evaluation data for a corresponding item record.

18. A system comprising:
circuitry configured to:
receive, via a communication interface coupled to a packet-switched network, a natural language request from a terminal device;
generate a first prompt sentence encoding the natural language request, and input the first prompt sentence to a generative neural network model to extract structured need information comprising an event identifier, a recipient attribute, and a constraint parameter;
retrieve, from a storage device, a plurality of item records comprising sales performance data and evaluation comment text based on the structured need information;
apply a natural language processing pipeline to the evaluation comment text comprising text segmentation, linguistic classification, feature term extraction, and sentiment polarity scoring to generate feature information and evaluation trend information for each item record;
compute a composite evaluation value for each item record using a weighted combination of the feature information, the evaluation trend information, and the sales performance data, and rank the item records to select candidate item records;
generate a recommendation prompt sentence encoding the structured need information and the candidate item records, execute the generative neural network model to generate natural language recommendation text, and transmit response data comprising the recommendation text to the terminal device via the communication interface.

19. The system according to claim 18, wherein the circuitry is configured to detect an emotional state of a user from at least one of voice data or text data received from the terminal device, apply an emotion identification model to generate an emotional state indicator, and incorporate the emotional state indicator into the recommendation prompt sentence to adapt a tone and content of the recommendation text.

20. A method comprising:
receiving, via a communication interface coupled to a packet-switched network, a natural language request from a terminal device;
generating a first prompt sentence encoding the natural language request, and inputting the first prompt sentence to a generative neural network model to obtain structured need information comprising at least an event identifier, a recipient attribute, and a constraint parameter;
executing query processing on a storage device storing transaction history data and evaluation data based on the structured need information to retrieve a plurality of item records comprising sales performance data and evaluation comment text;
applying natural language processing to the evaluation comment text to perform segmentation and linguistic classification, calculate feature terms and a sentiment polarity value for each item record, and generate feature information and evaluation trend information for each item record;
computing, for each item record, a composite evaluation value based on at least the feature information, the evaluation trend information, and the sales performance data, and ranking the item records based on the composite evaluation value to select candidate item records;
generating a recommendation prompt sentence by encoding the structured need information and information on the selected candidate item records, inputting the recommendation prompt sentence to the generative neural network model to obtain natural language recommendation text describing the candidate item records; and
transmitting, via the communication interface, response data comprising the recommendation text and candidate item information to the terminal device.
